(19) United States
(12) Patent Application Publication
(10) Pub. No.: US 2003/0005241 A1
(43) Pub. Date: Jan. 2, 2003

(54) Write protect method

(76) Inventor: Tomoo Ueno, Kanagawa (JP)

Correspondence Address: Darryl G. Walker, WALKER & SAKO, LLP, Suite 235, 300 South First Street, San Jose, CA, 95113, US

(21) Appl. No.: 10/180,876

(22) Filed: Jun. 26, 2002

(30) Foreign Application Priority Data
Jun. 29, 2001 (JP) 2001-199080

(51) Int. Cl. G06F 12/00

(52) U.S. Cl. 711/156; 711/158; 711/163

(57) ABSTRACT

A write protect system (100) including a write protect circuit (10) that may provide write protection for a protected register (1) has been disclosed. Write protect circuit (10) may detect whether or not a write sequence (600) has been followed. Write sequence (600) may include first (901), second (902), and third (903) commands. First command (901) may include a write of data to a protected register (1). Second command (902) may include a write of inverted data to a protected register (1). A third command (903) may include a write of data to a protected register (1). Write protect circuit (10) may only allow a write to a protected register (1) if write sequence (600) has been followed. In this way, a protected register (1) may be protected against erroneous writes and a system (100) including a CPU (6) may have improved reliability.

### TECHNICAL FIELD

The present invention relates generally to a write protect method and more particularly to a write protect method that may prevent an erroneous write to a microcomputer control register or the like.

### BACKGROUND OF THE INVENTION

Because of the broad use of microcomputers in systems, it can be desirable to prevent an erroneous write to control registers. This is particularly important if the control register may have a significant influence on the operation of the system. For example, if a boot sector in a flash memory is inappropriately altered, a system may not properly boot even if reset. Thus, it can be extremely important to prevent an erroneous write to occur in a control register, or the like, which is involved in a self-write function of a flash memory.

The above-mentioned need is addressed by Japanese Patent Application Laid Open No. Hei 08-235073 (JPA '073). Referring to FIG. 28, a block diagram of a conventional write protect circuit as disclosed in JPA '073 is set forth. JPA '073 provides a protection controlling register in a write protect circuit 13 that retains information for determining whether to prohibit writing of data to a control register 1 to be protected. When a write operation occurs, a control register (1 to n) to which data is to be written into is specified. If the control register (1 to n) to which data is to be written into is control register 1 (a protected control register), a write signal wr_reg is controlled in accordance with information in protection control register in write protect circuit 13.

However, conventional write protect circuit of FIG. 28 does not include a function to confirm whether or not the write data has an error. As a result, a problem can occur if data on a data bus 8 has been unexpectedly corrupted. In this case, the write cannot be invalidated and corrupted data can be written into the protected control register 1.

In view of the above discussion, it would be desirable to provide a write protection circuit that may prevent erroneous data from being written into a predetermined register, or the like and method therefore.

### SUMMARY OF THE INVENTION

According to the present embodiments, a write protect system may include a write protect circuit that may provide write protection for a protected register. A write protect circuit may detect whether or not a write sequence has been followed. A write sequence may include a first command, a second command, and a third command. A first command may include a write of data to a protected register. A second command may include a write of inverted data to a protected register. A third command may include a write of data to a protected register. Write protect circuit may only allow a write to a protected register if a write sequence has been followed. In this way, a protected register may be protected against erroneous writes and a system including a CPU (central processing unit) may have improved reliability.

According to one aspect of the embodiments, a write protect method may prevent an erroneous write to a predetermined register. The write protect method may include the steps of determining whether or not a write operation for writing data to the predetermined register was performed according to a predetermined write sequence. The predetermined write sequence may include at least a first and second write command. The method may also control writing of the data to the predetermined register so that the writing of data is only performed when it is determined in the determining step that the write operation for writing data to the predetermined register was performed according to the predetermined write sequence.

According to another aspect of the embodiments, the step of determining may include verifying the data by performing a data comparison.

According to another aspect of the embodiments, the first write command may include providing the data on a data bus and providing a first address corresponding to the predetermined register. The second write command may include providing inverse data on the data bus and providing the first address corresponding to the predetermined register.

According to another aspect of the embodiments, a predetermined write sequence may include a third write command. A third write command may include providing the data on the data bus and providing the first address corresponding to the predetermined register. A predetermined write sequence may be executed in the order of first write command, second write command, and third write command.

According to another aspect of the embodiments, a predetermined write sequence may include a third write command. A third write command may include providing a predetermined value on the data bus and providing a second address. A predetermined write sequence may be executed in the order of third write command, first write command, and second write command.

According to another aspect of the embodiments, the write protect method may further include the step of providing an error signal to a processing unit when it is determined that the write operation for writing data to the predetermined register was not performed according to the predetermined write sequence.

According to another aspect of the embodiments, a step of determining whether or not a write operation has been performed may be executed by a computing device in accordance with a write protect program.

According to another aspect of the embodiments, a write protect system for preventing an erroneous write to a first register may include a write protect circuit. A write protect circuit may determine whether or not a write operation for writing data to the first register was performed according to a predetermined write sequence. The predetermined write sequence may include a first command and a second command. The write protect circuit may control the writing of the data to the first register so that the writing of data may be only performed when it is determined that the write operation for writing data to the first register was performed according to the predetermined write sequence.

According to another aspect of the embodiments, the write protect circuit may be coupled to receive the data from a data bus coupled to a processor.

According to another aspect of the embodiments, the write protect circuit is coupled to receive the data in the first command and coupled to receive different data in the second command.

According to another aspect of the embodiments, the predetermined write sequence may include a third command. The write protect circuit may be coupled to receive the data in the third command. The predetermined write sequence may be executed in the order of first command, second command, and third command.

According to another aspect of the embodiments, the write protect circuit may be coupled to receive at least one register select signal. The at least one register select signal may have a first register select value in the first and second commands. The predetermined write sequence may include a third command. The write protect circuit may be coupled to receive a predetermined data value in the third command and at the least one register select signal may have a command register select value.

According to another aspect of the embodiments, the write protect circuit may reset to detect the first command in the predetermined sequence when it is determined that the predetermined sequence has not been followed.

According to another aspect of the embodiments, the write protect circuit may receive the data in the first command and may receive inverse data in the second command.

According to another aspect of the embodiments, a write protect system may prevent an erroneous write to a first storage circuit. A write protect system may include a write protect circuit. A write protect circuit may determine whether or not a write operation for writing data to the first storage circuit was performed according to a predetermined write sequence. The predetermined write sequence may include at least a first command and a second command. The write protect circuit may control the writing of the data to the first storage circuit so that the writing of data may only be performed when it is determined that the write operation for writing data to the first storage circuit was performed according to the predetermined write sequence.

According to another aspect of the embodiments, the write protect circuit may include a data latch circuit. The data latch circuit may receive the data and provide latched data in response to the first command.

According to another aspect of the embodiments, the write protect circuit may include a comparator circuit. The comparator circuit may receive the latched data and second command data and provide a comparison result.

According to another aspect of the embodiments, a comparison result may include a match signal indicating a comparison between the latched data and the second command data.

According to another aspect of the embodiments, the write protect circuit may include a state circuit. The state circuit may provide a write sequence state. The write sequence state may indicate a progression of the write sequence.

According to another aspect of the embodiments, the write protect circuit may include a sequence error detector. The sequence error detector may receive the write sequence state and provide a sequence error signal.

According to another aspect of the embodiments, the write protect circuit may include a first storage circuit write signal generator. The first storage circuit write signal generator may receive the write sequence state and provide a first storage circuit write signal.

### BRIEF DESCRIPTION OF THE DRAWINGS

FIG. 1 is a block schematic diagram of a system including a write protect circuit according to an embodiment.

FIG. 2 is a circuit schematic diagram of a write protect circuit according to an embodiment.

FIG. 3 is a state diagram illustrating a status progression of a count signal according to an embodiment.

FIG. 4 is a circuit schematic diagram of a step counter according to an embodiment.

FIG. 5 is a circuit schematic diagram of a sequence error detector according to an embodiment.

FIG. 6 is a flow chart illustrating a write sequence according to an embodiment.

FIG. 7 is a timing diagram of a write to a protected register using a write sequence according to an embodiment.

FIG. 8 is a timing diagram illustrating a case where an erroneous write operation to a register other than a protected register occurs after step 1 according to an embodiment.

FIG. 9 is a timing diagram illustrating a case where an erroneous write operation occurs after step 1 with a value other than inverted data according to an embodiment.

FIG. 10 is a timing diagram illustrating a case where an erroneous write operation to a register other than protected register occurs after step 2 according to an embodiment.

FIG. 11 is a timing diagram illustrating a case where an erroneous write operation occurs after step 2 with a value other than data according to an embodiment.

FIG. 12 is a block schematic diagram of a system including a write protect circuit according to an embodiment.

FIG. 13 is a circuit schematic diagram of a write protect circuit according to an embodiment.

FIG. 14 is a circuit schematic diagram of an object register detector according to an embodiment.

FIG. 15 is a state diagram illustrating a status progression of a count signal according to an embodiment.

FIG. 16 is a circuit schematic diagram of a step counter according to an embodiment.

FIG. 17 is a timing diagram of a write to a protected register using a write sequence according to an embodiment.

FIG. 18 is a timing diagram illustrating a case where an erroneous write operation to a register other than the object protected register occurs after step 2 according to an embodiment.

FIG. 19 is a block schematic diagram of a system including a write protect circuit according to an embodiment.

FIG. 20 is a circuit schematic diagram of write protect circuit according to an embodiment.

FIG. 21 is a state diagram illustrating a status progression of a count signal according to an embodiment.

FIG. 22 is a circuit schematic diagram of a step counter according to an embodiment.

FIG. 23 is a circuit schematic diagram of a sequence error detector according to an embodiment.

FIG. 24 is a flow chart illustrating a write sequence according to an embodiment.

FIG. 25 is a timing diagram of a write to a protected register using a write sequence according to an embodiment.

FIG. 26 is a timing diagram illustrating a case where an erroneous write operation to protected register occurs without a preceding write operation writing 55AAh to a command register according to an embodiment.

FIG. 27 is a timing diagram illustrating a case where an erroneous write operation may occur after step 3 with a value other than data according to an embodiment.

FIG. 28 is a block diagram of a conventional write protect circuit.

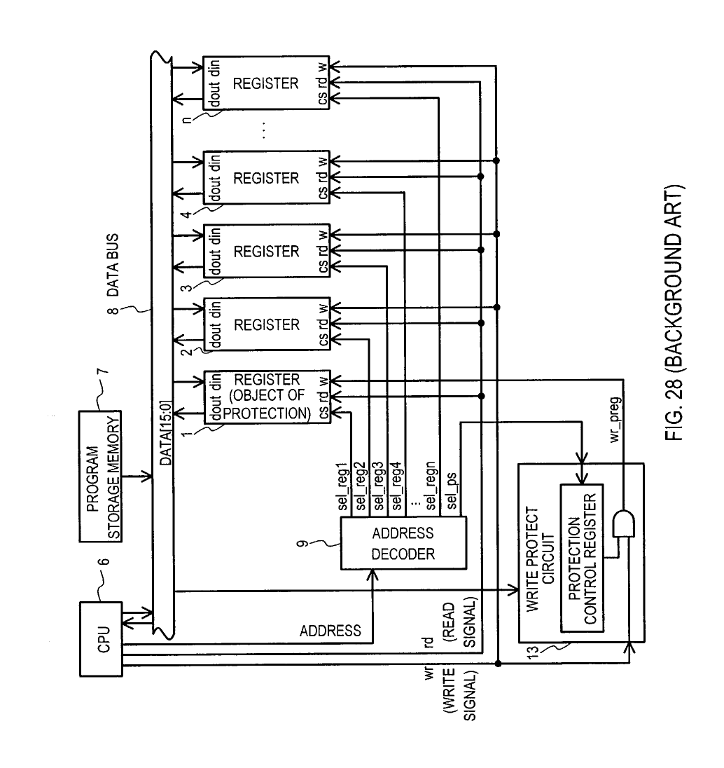

### DETAILED DESCRIPTION OF THE EMBODIMENTS

The present invention may prevent a write error to a control register. For example, a write protection circuit may be provided for a control register that may significantly influence operation of a system. A write protection circuit may only permit a write operation when a specific sequence is performed. If a specific sequence is not performed, a write operation may be invalidated. In such a sequence, the validity (correctness) of write data may be confirmed. The validity may be confirmed before a write control signal is applied to the control register.

Various embodiments of the present invention will now be described in detail with reference to a number of drawings.

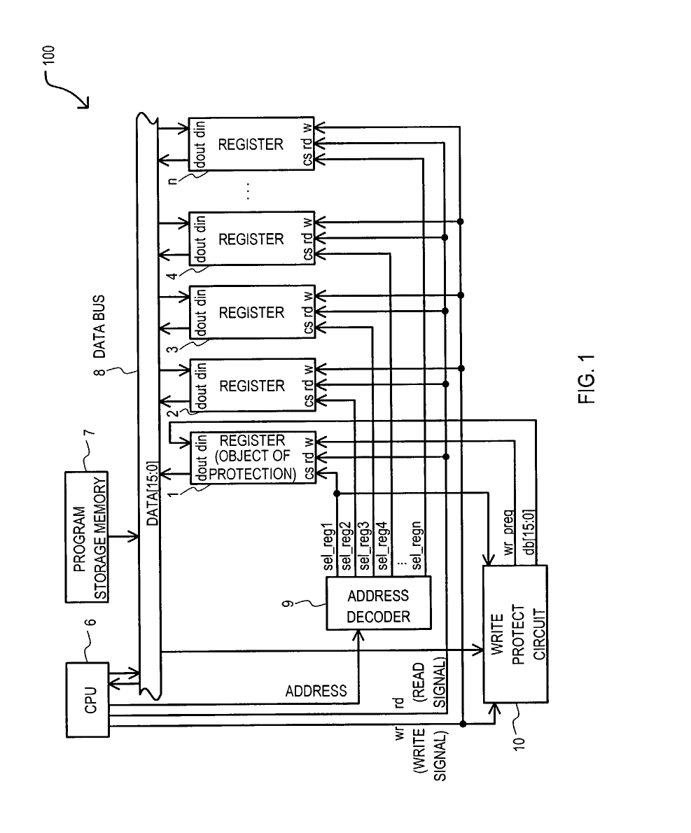

Referring now to FIG. 1, a block schematic diagram of a system including a write protect circuit is set forth according to an embodiment and given the general reference character 100.

System 100 may include a register 1. Register 1 may have a significant influence on the operation of system 100. Thus, a write protect circuit 10 may be included. Write protect circuit 10 may only permit data to be written into register 1 when a write operation is performed according to a specific sequence.

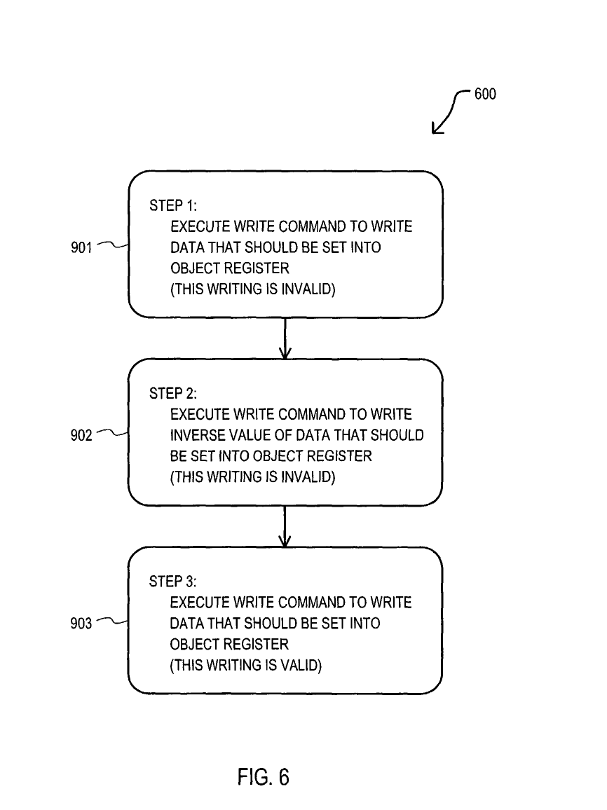

Referring to FIG. 6, a flow chart illustrating a write sequence according to an embodiment is set forth and given the general reference character 600.

Write sequence 600 may include 3 steps illustrated as step 1 901 through step 3 903. Write protect circuit 10 (FIG. 1) may only permit data to be written into register 1 when a write operation specifically follows write sequence 600. In a case where write sequence 600 is not followed, the write operation may become invalid. For example, if another write operation is performed between step 1 901 and step 2 902 or between step 2 902 and step 3 903, the writing may become invalid.

In this way, for example in a system 100 (such as a computing device, for example) as illustrated in FIG. 1, even when an erroneous write to register 1 occurs due to a system abnormality, for example, runaway by a CPU (central processing unit) 6 causing erroneous data on a data bus 8, the write operation may be invalidated unless performed in accordance with write sequence 600. Thus, an erroneous write may be prevented.

A detailed explanation will now be made of a system 100 which may include a write protection circuit 10. System 100 may include registers (1 to n), a CPU 6, a program storage memory 7, a data bus 8, an address decoder 9, and a write protect circuit 10. CPU 6 may provide control for system 100. Program storage memory 7 may store a program, for example.

CPU 6 may read (via data bus 8) and execute a predetermined control program stored in program storage memory 7. CPU 6 may provide a write signal wr to write protect circuit 10 and registers (2 to n, where n may be a natural number corresponding to the total number of registers). Write signal wr may be a control signal instructing registers (2 to n) to receive data from data bus 8. CPU 6 may provide a read signal rd to registers (1 to n). Read signal rd may be a control signal instructing registers (1 to n) to provide data to data bus 8. CPU 6 may provide and/or receive data to/from data bus 8. Program storage memory 7 may store a predetermined control program and may supply various data to data bus 8. A predetermined control program stored in program storage memory 7 may provide control instructions, for example, to CPU 6. Address decoder 9 may receive an address ADDRESS from CPU 6 and may provide selection signals (sel_reg1 to sel_regn) to respective registers (1 to n). Selection signals (sel_reg1 to sel_regn) may be selectively activated in accordance with address ADDRESS. Selection signal sel_reg1 may be provided to write protect circuit 10. Write protect circuit may provide a write signal wr_preg and data db[15:0] to register 1. Data DATA[15:0] may be provided to registers (2 to n) through data bus 8. Registers (1 to n) may provide data DATA[15:0] to data bus 8 in a read from register operation.

In the present embodiment, data bus 8 may have a 16-bit width and address ADDRESS may be applied to a separate bus, however, the present invention may be applicable to other bus sizes and constructions. Register 1 may be a register that can be protected from undesired/erroneous writes by write protect circuit 10.

As illustrated in the embodiment of FIG. 1, in a write operation, data DATA[15:0] may be provided directly to data inputs din of registers (2 to n) via data bus 8 without write protection. Further, write signal wr may be provided directly to a write input terminal w of registers (2 to n) from CPU 6. However, in a write operation, data DATA[15:0] may not be applied directly to a data input din of register 1. Instead, data DATA[15:0] may be applied to write protect circuit 10. Likewise, in a write operation, write signal wr may not be applied directly as a control signal to a write input terminal w of register 1. Instead write signal wr may be applied to write protect circuit 10.

When a write command for any of registers (1 through n) is executed, address ADDRESS may be provided from CPU to address decoder 9. Address decoder 9 may activate a select signal (sel_reg1 to sel_regn) corresponding to the address ADDRESS. A select signal (sel_reg1 to sel_regn) may be received at a select input terminal cs of a respective register (1 to n). An active select signal (sel_reg1 to sel_regn) may have a logic high level. In this way, a predetermined register (1 to n) may be selected in accordance with an address ADDRESS. For example, in a case where data is to be written to register 2, select signal sel_reg2 may become active (logic high) and data DATA[15:0] may be written from data bus 8 into register 2 when write signal wr pulses high. In contrast, when data is to be written to register 1, select signal sel_reg1 may become active (logic high). However, this may only complete step 1 901 (FIG. 6) of a write operation to protected register 1.

As explained above, a predetermined value may be directly written into registers (2 through n), which are not write protected by applying a write signal wr from CPU 6. However, because a write signal wr_preg applied to a write terminal w of register 1 is controlled by write protect circuit 10, register 1 may not be written to unless a write operation following a specific sequence 600 (FIG. 6) is executed.

Write protect circuit 10 may provide a write control such that only when a write is executed in a specific sequence 600 will data be allowed to be written into register 1 (a protected register). For example, writing to a protected register may only be valid when performed according to the 3 steps (901, 902, and 903) as illustrated in sequence 600 of FIG. 6. Step 1 901 may include executing a write command with data DATA[15:0] set as data (write data) to be written into register 1. Step 2 902 may include executing a write command with data DATA[15:0] set as inverse data (inverse write data) to be written into register 1. Step 3 903 may include executing a write command with data DATA[15:0] set as data (write data) to be written into register 1. Upon the detection of steps the 3 steps (901, 902, and 903) executed in succession, write protect circuit 10 may provide data db[15:0] and a write control signal wr_preg to allow write data to be written into register 1.

At the time of the execution of step 1 901 and step 2 902, the writing may still be deemed invalid and, as such, write protect circuit 10 may not output write signal (write pulse) wr_preg. Write signal (write pulse) wr_preg may only be output when a write operation includes the 3 steps (901, 902, and 903) executed in order.

In a case where step 1 901 through step 3 903 are not sequentially executed (for example another write operation is performed between step 1 901 and step 2 902 or between step 2 902 and step 3 903), a sequence error may be protected and the write may become invalid. Once a write has become invalid, an attempted re-write may not be successful unless sequence 600 is completed beginning again from step 1 901.

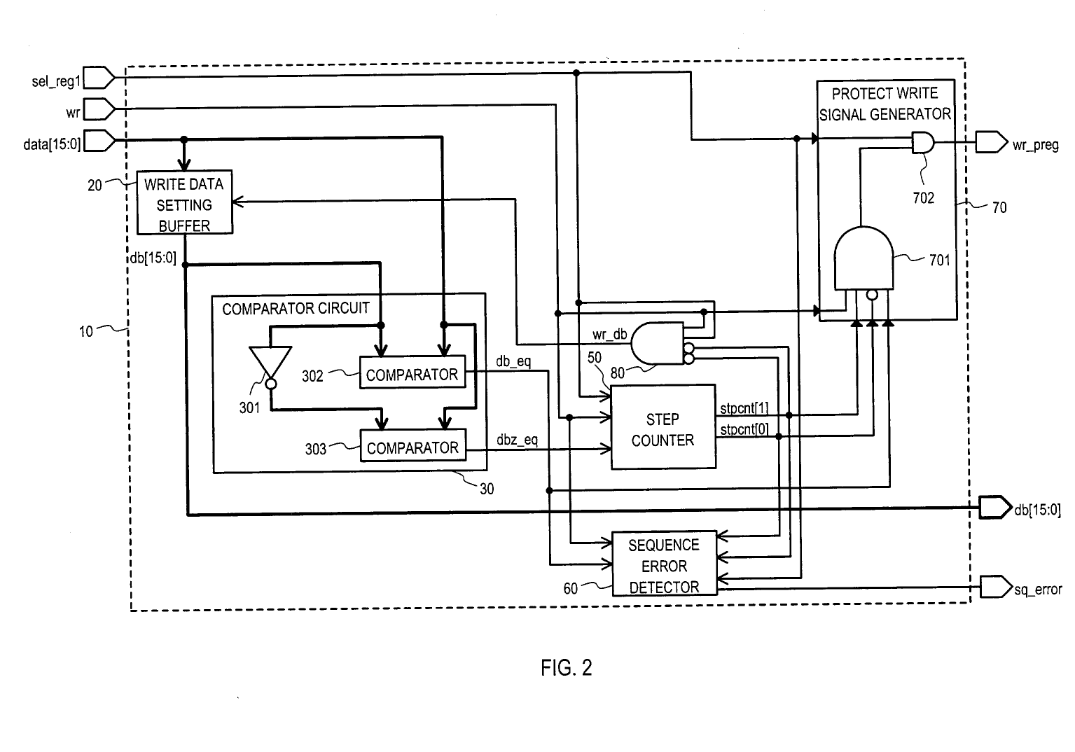

Referring now to FIG. 2, a circuit schematic diagram of write protect circuit 10 according to an embodiment is set forth.

Write protect circuit 10 may include a write data setting buffer 20, a comparator circuit 30, a step counter 50, a sequence error detector 60, a protect write signal generator 70, and an AND element 80.

Write data setting buffer 20 may receive data DATA[15:0] and a signal wr_db and may provide data db[15:0]. Write data setting buffer 20 may latch a value of data data[15:0] received at step 1 901 to provide data db[15:0]. Write data setting buffer 20 may be a 16-bit buffer.

Comparator circuit 30 may receive data data[15:0] and data db[15:0] and may provide match signals (db_eq and dbz_eq). Comparator circuit 30 may perform data comparison. Comparator circuit 30 may include comparing units (302 and 303) and an inverter 301. Comparing unit 302 may compare a value of data DATA[15:0] from bus 8 with latched data db[15:0] and output a match signal db_eq. Comparing unit 303 may receive inverted latched data db[15:0] through inverter 301. Comparing unit 303 may compare a value of data data[15:0] from bus 8 with inverted latched data db[15:0] and output a match signal dbz_eq.

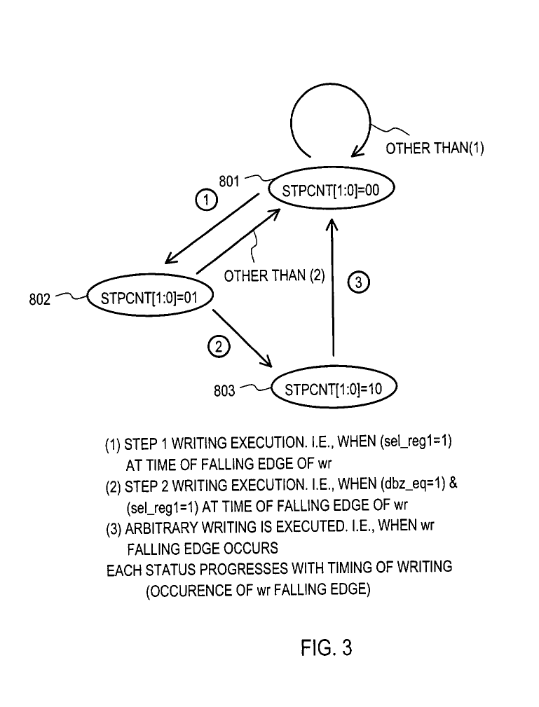

Step counter 50 may receive select signal sel_reg1, write signal wr and match signal dbz_eq and may provide a count signal stpcnt[1:0]. Count signal stpcnt[1:0] may be a 2-bit count signal including count bits (stpcnt[1] and stpcnt[0]). A value of count signal stpcnt[1:0] may indicate a step of sequence 600 being carried out. Count signal stpcnt[1:0]=00b (00b indicates count bit stpcnt[1]=0 and count bit stpcnt[0]=0, with b indicating binary), may indicate sequence 600 is not currently being carried out or followed. Count signal stpcnt[1:0]=01b may indicate that step 1 901 of sequence 600 has been completed. Count signal stpcnt[1:0]=10b may indicate that step 2 902 of sequence 600 has been completed. A status progression of count signal is illustrated in FIG. 3.

Referring now to FIG. 3, a state diagram illustrating a status progression of count signal stpcnt[1:0] according to an embodiment is set forth.

Step counter 50 may receive match signal dbz_eq, write signal wr, and select signal sel_reg1 and provide count signal stpcnt[1:0] accordingly in response to an execution of a write command by CPU 6 (FIG. 1). More specifically, count signal stpcnt[1:0] may be set to a state (801 to 803) in response to a falling edge of write signal wr pulse provided by CPU 6.

If count signal stpcnt[1:0]=00b (state 801) and step 1 901 of a write operation is performed, count signal stpcnt[1:0] may progress to a value of 01b (state 802). Then, if step 2 902 of a write operation is performed, count signal stpcnt[1:0] may progress to a value of 10b (state 803). When a different write occurs, count signal stpcnt[1:0] may return to a value of 00b. When count signal stpcnt[1:0] has a value of 10b and a write occurs, count signal stpcnt[1:0] may return to a value of 00b.

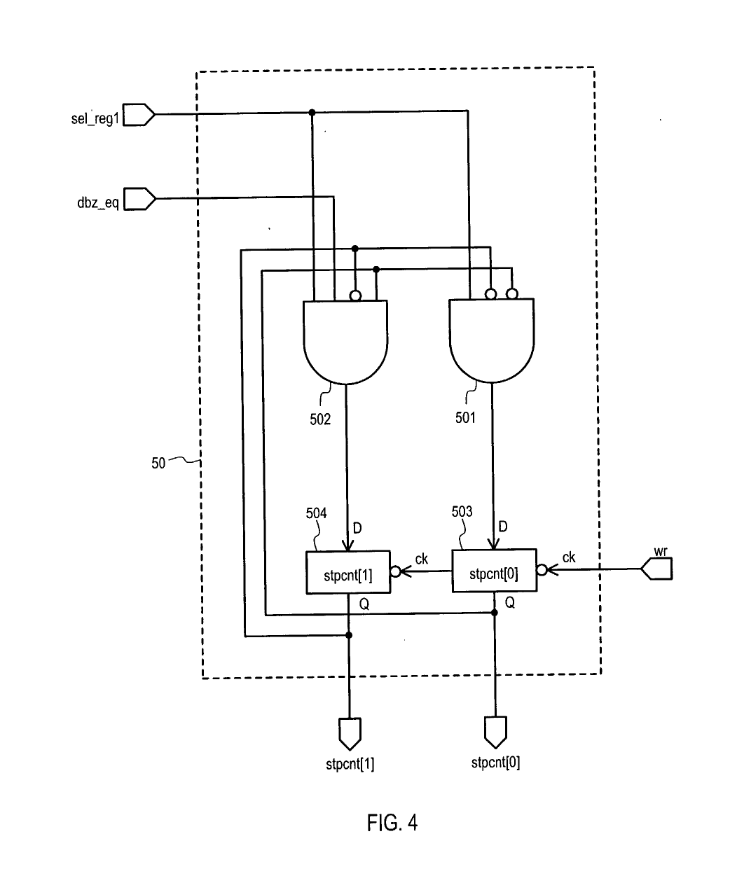

Referring now to FIG. 4, a circuit schematic diagram of step counter 50 according to an embodiment is set forth. Step counter 50 may provide count signal stpcnt[1:0] by following the state diagram illustrated in FIG. 3.

Step counter 50 may include AND gates (501 and 502) and flip-flop circuits (503 and 504). Flip-flop circuits (503 and 504) may be D-type flip-flop circuits. AND gate 501 may receive select signal sel_reg1, inverted count bit stpcnt[0] and inverted count bit stpcnt[1] and may provide a logical product output as an input to flip-flop circuit 503. AND gate 502 may receive select signal sel_reg1, match signal dbz_eq, count bit stpcnt[0] and inverted count bit stpcnt[1] and may provide a logical product output as an input to flip-flop circuit 504.

Flip-flop circuit 503 may receive the logical product output from AND gate 501 and write signal wr. Flip-flop circuit 503 may latch the logical product output from AND gate 501 in response to an inverted write signal wr (i.e. at a falling edge of write signal wr) to provide count bit stpcnt[0] of count signal stpcnt[1:0]. Flip-flop circuit 504 may receive the logical product output from AND gate 502 and write signal wr. Flip-flop circuit 504 may latch the logical product output from AND gate 502 in response to an inverted write signal wr (i.e. at a falling edge of write signal wr) to provide count bit stpcnt[1] of count signal stpcnt[1:0].

Referring once again to FIG. 2, sequence error detector 60 may receive match signal db_eq, write signal wr, count signal stpcnt[1:0], and select signal sel_reg1 and may provide an error signal sq_error. Sequence error detector 60 may detect whether write sequence 600 has been performed normally (followed) or not. When write sequence 600 is not followed, sequence error detector 60 may provide error signal sq_error having an error logic state. Error signal sq_error may be provided to CPU 6 (FIG. 1) as a flag, an interrupt request or the like even though this connection is not illustrated in FIG. 1. Error signal sq_error may indicate that a different write operation was performed between step 1 901 and step 2 902 or between step 2 902 and step 3 903 in write sequence 600 (FIG. 6).

Examples of four cases will be given when error signal sq_error may indicate an invalid write (first write). For example, in a first case, a first write operation to a register other than protected register 1 may occur after step 1 901. In a second case, a first write operation may occur after step 1 901 with a value other than inverted data (as compared to data DATA[15:0] in step 1 901). In a third case, a first write operation to a register other than protected register 1 may occur after step 2 902. In a fourth case, a first write operation may occur after step 2 902 with a value other than data (data DATA[15:0] in step 1 901). When any of the four above-mentioned cases occur, sequence 600 has been interrupted or violated. In response to the violation of sequence 600, writing to register 1 (a register protected by write protect circuit 10) may be invalidated and thus, not take place and error signal sq_error may be output having an error logic state.

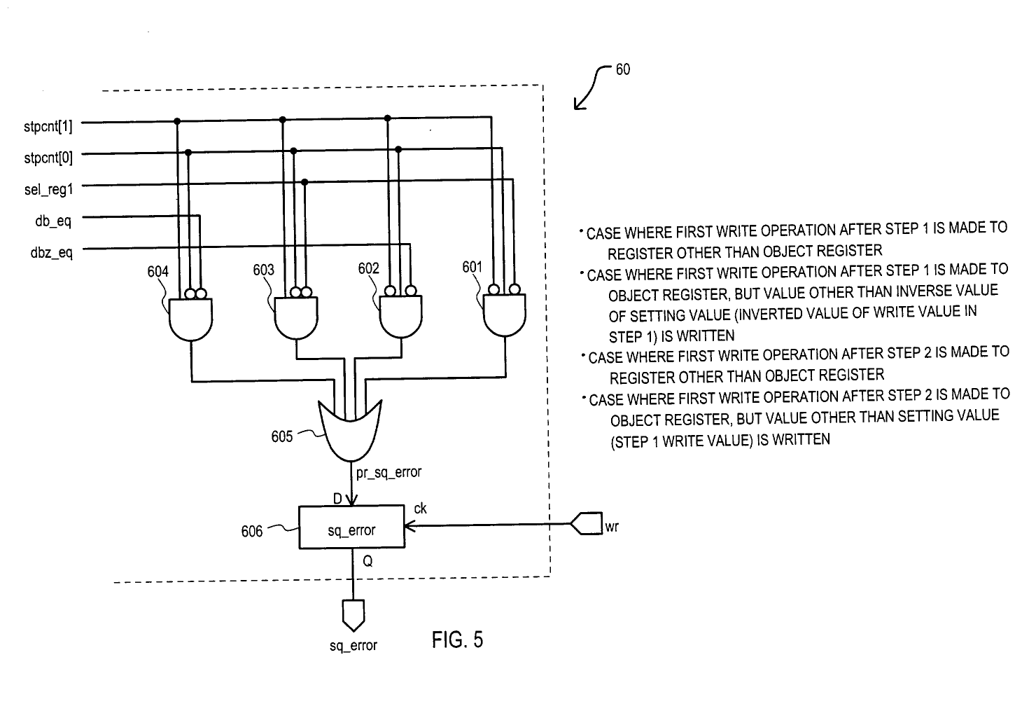

Referring now to FIG. 5, a circuit schematic diagram of sequence error detector 60 according to an embodiment is set forth.

Sequence error detector 60 may include AND gates (601 to 604), OR gate 605, and flip-flop circuit 606.

AND gate 601 may receive an inverted select signal sel_reg1, inverted step count bit stpcnt[1], and step count bit stpcnt[0] and may provide an output as an input to OR gate 605. AND gate 602 may receive step count bit stpcnt[0], inverted step count bit stpcnt[1], and inverted match signal dbz_eq and may provide an output as an input to OR gate 605. AND gate 603 may receive an inverted select signal sel_reg1, step count bit stpcnt[1], and inverted step count bit stpcnt[0] and may provide an output as an input to OR gate 605. AND gate 604 may receive an inverted match signal db_eq, step count bit stpcnt[1], and inverted step count bit stpcnt[0] and may provide an output as an input to OR gate 605.

OR gate 605 may provide an output signal pr_sq_error as an input to flip-flop 606.

Flip-flop 606 may be a D-type flip-flop. Flip-flop 606 may receive write signal wr at a clock input ck and may output error signal sq_error. Flip-flop 606 may latch the received signal pr_sq_error to provide error signal sq_error in response to a rising edge of write signal wr.

The above-mentioned first case may be detected by AND gate 601. The second case may be detected with AND gate 602. The third case may be detected with AND gate 603. The fourth case may be detected with AND gate 604. Output signals from AND gates (601 to 604) may be respectively provided as inputs to OR gate 605 to generate output signal pr_sq_error which may be latched by flip-flop 606 in response to a rising edge of write signal wr and output as error signal sq_error.

Referring once again to FIG. 2, protect write signal generator 70 may receive select signal sel_reg1, write signal wr, count signal stpcnt[1:0], and match signal db_eq and may provide a write signal wr_preg. Protect write signal generator 70 may include AND gate 701 and AND gate 702.

AND gate 701 may receive write signal wr, count bit stpcnt[1], inverted count bit stpcnt[0], and match signal db_eq as inputs and may provide an output signal as an input to AND gate 702. AND gate 702 may receive select signal sel_reg1 as an input and may output write signal w_preg.

AND gate 701 may detect an execution of step 3 903 indicating that the sequence 600 has been followed. AND gate 702 may detect that protected register 1 is the selected register being written to. AND gate 702 may generate write signal w_preg if the output of AND gate 701 is a high logic level and select signal sel_reg1 is high (indicating register 1 is selected).

AND gate 80 may receive select signal sel_reg1, write signal wr, inverted count bit stpcnt[1], and inverted count bit stpcnt[0] as inputs and may output a signal wr_db. Signal wr_db may be provided to write data setting buffer 20 to trigger the latching of data DATA[15:0] to provide data db[15:0]. AND gate 80 may detect an execution of step 1 901 (FIG. 6) indicating sequence 600 may be followed. Signal wr_db may be generated when select signal sel_reg1 has a high logic value, write signal wr has a high logic value, and count signal stpcnt[1:0]=00 (i.e. count bit stpcnt[1]=0 and count bit stpcnt[0]=0). In this way, AND gate 80 may detect an execution of a step 1 of sequence 600 for a write to a protected register 1 and data data[15:0] on data bus 8 may be latched by write data setting buffer 20 and used for verification of subsequent steps (step 2 902 and step 3 903).

The operation of the system 100 including write protect circuit 10 will now be explained.

First, an operation where a write to a protected register using sequence 600 will be explained.

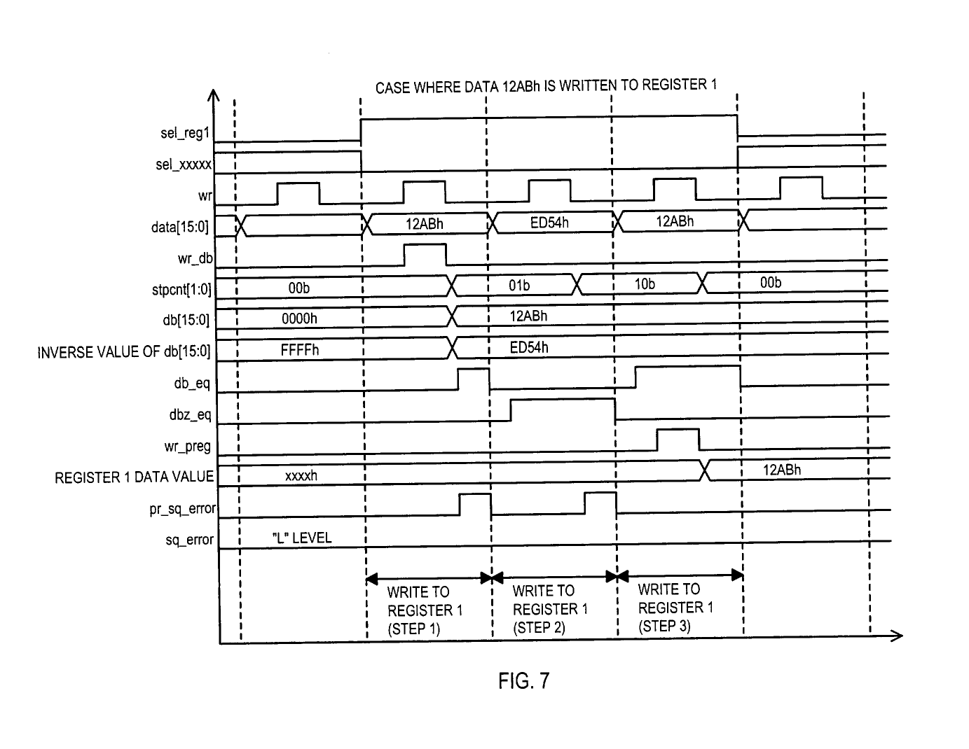

Referring to FIG. 7, a timing diagram of a write to a protected register using sequence 600 according to an embodiment is set forth. The timing diagram of FIG. 7 illustrates a write of data DATA[15:0]=12ABh (h indicates that 12AB is a hexidecimal number) into register 1 following sequence 600 shown in FIG. 6.

Referring now to FIG. 7 in conjunction with FIGS. 1 to 6, a write command may be executed to register 1 as step 1 901. In step 1 901, select signal sel_reg1 may become active (high) while other select signals (sel_reg2 to sel_regn) may be low (illustrated as signal sel_xxxxx in FIG. 7). Also, in step 1 901, CPU 6 may apply a value of 12ABh as data data[15:0] to data bus 8 and may provide write signal wr having a pulse. Because at this time step counter 60 outputs a count signal stpcnt[1:0]=00b, AND gate 80 may output a signal wr_db as a pulse (following write signal wr). In response to signal wr_db, write data setting buffer 20 may latch received data data[15:0] and provide data db[15:0] having a value of 12ABh to comparator circuit 302. Inverter 301 may provide inverted data having a value of ED54h to comparator circuit 303. In this case, comparator circuit 302 may detect a match between data data[15:0] and data db[15:0] and may output a match signal db_eq having a high logic level. However, comparator circuit 303 may not detect a match between data DATA[15:0] and inverted data db[15:0] and may output a match signal dbz_eq having a low logic level.

Also, at this time, AND gate 501 in step counter 50 may be enabled (in response to count signal stpcnt[1:0]=00b and select signal sel_reg1 being high) and may provide a high output as an input to flip-flop circuit 503. As a result, flip-flop 503 may latch a high level count bit stpcnt[0] in response to a falling edge of write signal wr. In this way, count signal stpcnt[1] may advance to a value of 01b. However, because at this time write signal wr has returned to a logic low and count signal stpcnt[1:0]=01b, protect write signal generator 70 may not generate write signal wr_preg. Thus, contents of register 1 may not be modified in response to a write command of step 1 901.

Next, another write command may be executed as step 2 902. In step 2 902, select signal sel_reg1 may remain high while other select signals (sel_reg2 to sel_regn) may be low (illustrated as signal sel_xxxxx in FIG. 7). Also, in step 2 902, CPU 6 may apply a value of ED54h as data DATA[15:0] to data bus 8 and may provide write signal wr having a pulse. In this case, comparator circuit 303 may detect a match between data data[15:0] and inverted data db[15:0] and may output a match signal dbz_eq having a high logic level. However, comparator circuit 302 may not detect a match between data DATA[15:0] and data db[15:0] and may output a match signal db_eq having a low logic level.

Also, at this time, AND gate 501 in step counter 50 may be disabled (in response to count signal bit stpcnt[0]=1b) and may provide a low output as an input to flip-flop circuit 503. Also, at this time, AND gate 502 in step counter 50 may be enabled (in response to count signal stpcnt[1:0]=01b, select signal sel_reg1 being high, and match signal dbz_eq being high) and may provide a high output as an input to flip-flop circuit 504. As a result, flip-flop 503 may latch a high level count bit stpcnt[1] and flip-flop 502 may latch a low level count bit stpcnt[0] in response to a falling edge of write signal wr. In this way, count signal stpcnt[1:0] may advance to a value of 10b. However, because at this time, write signal wr has returned to a logic low and match signal db_eq is low, protect write signal generator 70 may not generate write signal wr_preg. Thus, contents of register 1 may not be modified in response to a write command of step 2 902.

Next, another write command may be executed as step 3 903. In step 3 903, select signal sel_reg1 may remain high while other select signals (sel_reg2 to sel_regn) may be low (illustrated as signal sel_xxxxx in FIG. 7). Also, in step 3 903, CPU 6 may apply a value of 12ABh as data DATA[15:0] to data bus 8 and may provide write signal wr having a pulse. In this case, comparator circuit 302 may detect a match between data data[15:0] and db[15:0] and may output a match signal db_eq having a high logic level. However, comparator circuit 303 may not detect a match between data data[15:0] and inverted data db[15:0] and may output a match signal dbz_eq having a low logic level.

At this time, AND gate 701 in protect write signal generator 70 may provide a high output (because count signal stpcnt[1:0]=10b, write signal wr is high, and match signal db_eq is high). Thus, AND gate 702 may generate write signal wr_preg. Write signal wr_preg may be a pulse essentially following write signal wr during step 3 903.

In response to write signal wr_preg having a pulse and select signal sel_reg1 being high, data db[15:0] (12ABh in the present example as latched by write data setting buffer 20) may be written into register 1.

Also, during step 3 903, in response to count signal stpcnt[1:0]=10b, AND gates (502 and 503) may both provide logic low outputs. As a result, flip-flop 503 may latch a low level count bit stpcnt[1] and flip-flop 502 may latch a low level count bit stpcnt[0] in response to a falling edge of write signal wr. In this way, count signal stpcnt[1:0] may return to a value of 00b. It is noted that count signal stpcnt[1:0] may return to a value of 00b after write signal wr_preg has been generated during step 3 903.

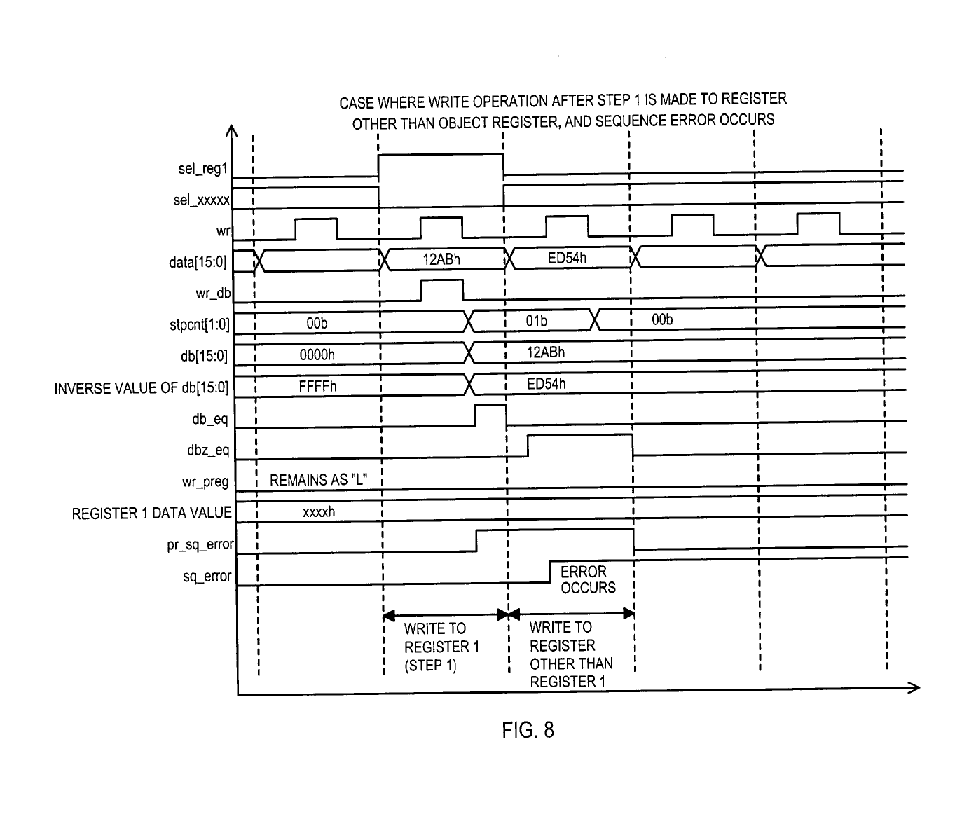

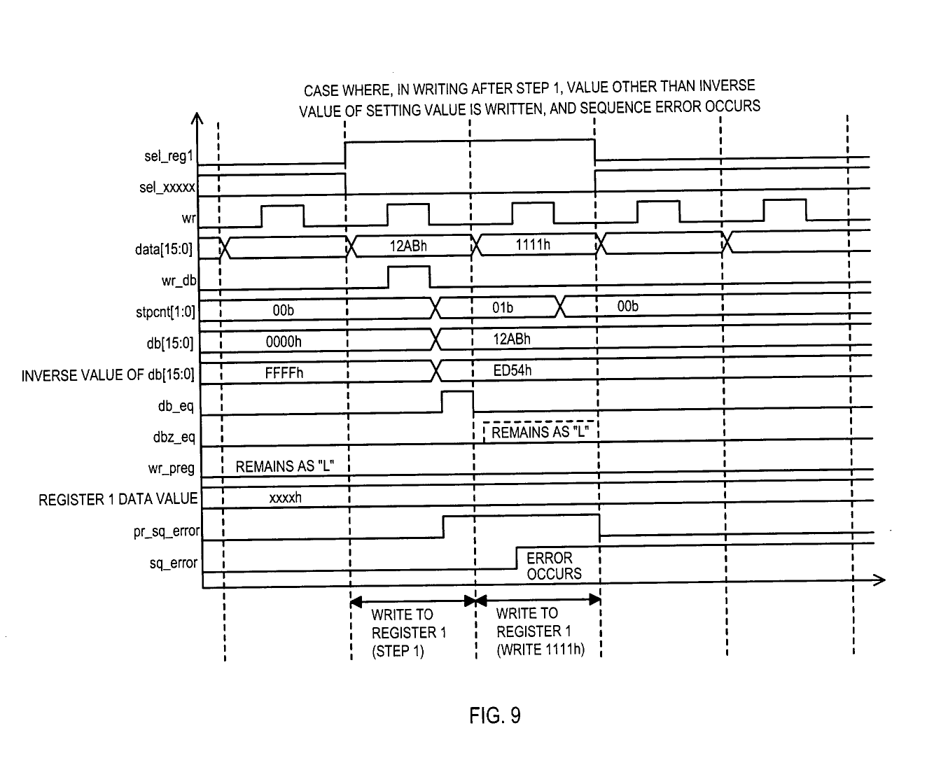

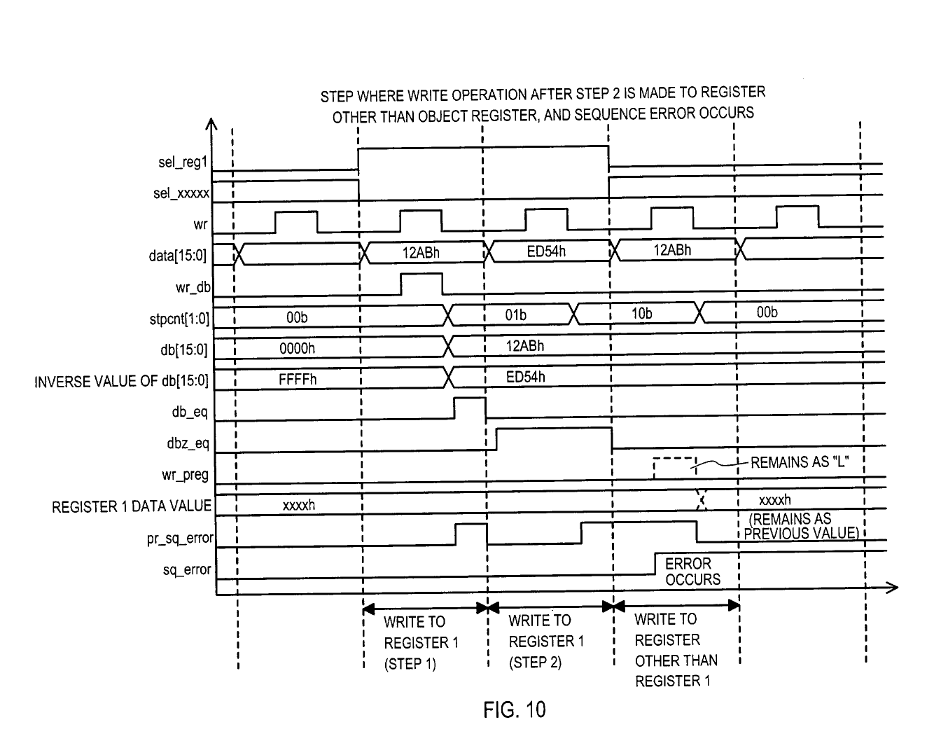

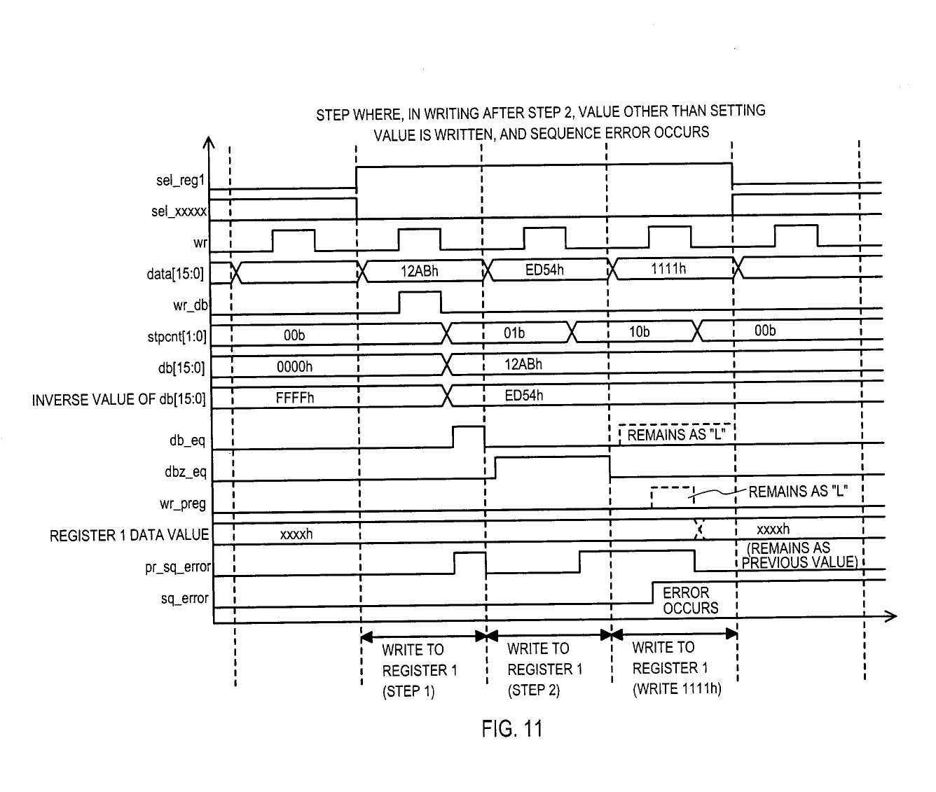

Now, using timing diagrams of FIGS. 8, 9, 10, and 11, an explanation will be made for cases where a write sequence is initiated to register 1, however, sequence 600 is not followed and the write becomes invalid. The timing diagrams of FIGS. 8, 9, 10, and 11 may respectively illustrate the four above-mentioned cases. FIG. 8 may illustrate a first case, where an erroneous write operation to a register other than protected register 1 may occur after step 1 901. FIG. 9 may illustrate a second case, where an erroneous write operation may occur after step 1 901 with a value other than inverted data (as compared to data data[15:0] in step 1 901). FIG. 10 may illustrate a third case, where an erroneous write operation to a register other than protected register 1 may occur after step 2 902. FIG. 11 may illustrate a fourth case, where an erroneous write operation may occur after step 2 902 with a value other than data (data DATA[15:0] in step 1 901).

Referring now to FIG. 8, a timing diagram illustrating a case where an erroneous write operation to a register other than protected register 1 may occur after step 1 901 according to an embodiment is set forth.

Referring now to FIG. 8 in conjunction with FIGS. 1 to 6, a write command may be executed to register 1 as step 1 901. Step 1 901 in FIG. 8 may be essentially the same as step 1 901 illustrated in the timing diagram of FIG. 7.

Next, a write (after step 1) is made to a register other than register 1. Thus, select signal sel_reg1 may change from high to low. AND gate 601 in sequence error detector may receive the low select signal sel_reg1 and count signal stpcnt[1:0]=01b and may provide a high output. In this way, OR gate 605 may provide an output signal pr_sq_error having a high logic level. Flip-flop 606 may then provide an error signal sq_error having a high logic level upon a rising edge of write signal wr.

Also, with select signal sel_reg1 having a low logic level, AND gates (501 and 502) in step counter 50 may each provide an output having a low logic level. In this way, count signal stpcnt[1:0] may be reset to 00b on a falling edge of write signal wr.

Referring now to FIG. 9, a timing diagram illustrating a case where an erroneous write operation may occur after step 1 901 with a value other than inverted data (as compared to data data[15:0] in step 1 901) according to an embodiment is set forth.

Referring now to FIG. 9 in conjunction with FIGS. 1 to 6, a write command may be executed to register 1 as step 1 901. Step 1 901 in FIG. 9 may be essentially the same as step 1 901 illustrated in the timing diagram of FIG. 7.

Next, a write (after step 1) is made to register 1 with data data[15:0] having a value other than inverted data (as compared to data data[15:0] in step 1 901). For example, data data[15:0] may have a value of 1111h while inverted data data[15:0] (from step 1) may have a value of ED54h. Thus, match signal dbz_eq may remain at a low logic level. AND gate 602 in sequence error detector may receive the low match signal dbz_eq and count signal stpcnt[1:0]=01b and may provide a high output. In this way, OR gate 605 may provide an output signal pr_sq_error having a high logic level. Flip-flop 606 may then provide an error signal sq_error having a high logic level upon a rising edge of write signal wr.

Also, with match signal dbz_eq having a low logic level, AND gate 502 in step counter 50 may provide an output having a low logic level. Also, because counter bit stpcnt[0]=1, AND gate 501 may provide an output having a low logic level. In this way, count signal stpcnt[1:0] may be reset to 00b on a falling edge of write signal wr.

Referring now to FIG. 10, a timing diagram illustrating a case where an erroneous write operation to a register other than protected register 1 may occur after step 2 902 according to an embodiment is set forth.

Referring now to FIG. 10 in conjunction with FIGS. 1 to 6, a write commands may be executed to register 1 as step 1 901 and step 2 902. Step 1 901 and step 2 902 in FIG. 10 may be essentially the same as Step 1 901 and step 2 902 illustrated in the timing diagram of FIG. 7.

Next, a write (after step 2) is made to a register other than register 1. Thus, select signal sel_reg1 may change from high to low. AND gate 603 in sequence error detector may receive the low select signal sel_reg1 and count signal stpcnt[1:0]=10b and may provide a high output. In this way, OR gate 605 may provide an output signal pr_sq_error having a high logic level. Flip-flop 606 may then provide an error signal sq_error having a high logic level upon a rising edge of write signal wr.

Also, with select signal sel_reg1 having a low logic level, AND gates (501 and 502) in step counter 50 may each provide an output having a low logic level. In this way, count signal stpcnt[1:0] may be reset to 00b on a falling edge of write signal wr. Furthermore, with select signal sel_reg1 having a low logic level, AND gate 702 in protect write signal generator 70 may provide a write signal wr_preg having a logic low level and a write to register 1 may be prevented.

Referring now to FIG. 11, a timing diagram illustrating a case where an erroneous write operation may occur after step 2 902 with a value other than data (as compared to data data[15:0] in step 1 901) according to an embodiment is set forth.

Referring now to FIG. 11 in conjunction with FIGS. 1 to 6, a write commands may be executed to register 1 as step 1 901 and step 2 902. Step 1 901 and step 2 902 in FIG. 11 may be essentially the same as step 1 901 and step 2 902 illustrated in the timing diagram of FIG. 7.

Next, a write (after step 2) is made to register 1 with data data[15:0] having a value other than data data[15:0] in step 1 901. For example, data data[15:0] may have a value of 1111h while data db[15:0] (from step 1) may have a value of 12ABh. Thus, match signal db_eq may remain at a low logic level. AND gate 604 in sequence error detector 60 may receive the low match signal db_eq and count signal stpcnt[1:0]=10b and may provide a high output. In this way, OR gate 605 may provide an output signal pr_sq_error having a high logic level. Flip-flop 606 may then provide an error signal sq_error having a high logic level upon a rising edge of write signal wr.

Also, in accordance with the state diagram of FIG. 3, because an arbitrary write is executed when step counter 50 is in state 803, count signal stpcnt[1:0] may be reset to 00b (state 801) on a falling edge of write signal wr. Furthermore, with match signal db_eq having a low logic level, AND gate 701 in protect write signal generator 70 may provide an output having a logic low. In this way, AND gate 702 may provide a write signal wr_preg having a logic low level and a write to register 1 may be prevented.

Thus, writing to a register 1 that is protected may be valid only when a write sequence is performed in accordance with sequence 600. Therefore, when a write command intended for a register (2 to n), which is not protected, for example, and erroneously is performed for a register 1 which is protected, the write may not be allowed and may be invalidated. In this way, values stored in a control register 1, for example, which may significantly influence a system may be protected. In contrast, in a conventional system, erroneous writing to registers may occur due to CPU runaway or the like.

A write sequence 600 may be performed having 3 steps. Write data db[15:0] (either inverted or not inverted) may be compared with data data[15:0] on a data bus 8 in step 1 901, step 2 902, and step 3 903. In this way, it may be confirmed whether or not write data db[15:0] is erroneous or is the intended write data. Thus, even in a case where unexpected data corruption occurs on data bus 8, the write may be invalidated and a write of erroneous data to register 1 may be prevented.

For data corruption on a data bus 8, a method exists for providing an extra bit (parity bit) for error correction and the like. However, in accordance with the present embodiment, it may not be necessary to add an extra bit to data bus 8. In this way, board area may be reduced and error correction circuitry may be eliminated.

Further, a method may be possible in which only hardware for temporarily storing the write data is needed and the data comparison (checking to see if write data is valid) may be performed by software. However, in this case, the software for valid data detection may increase the program code and time required for writing to a register. In comparison, by only executing a write command 3 times as in the present embodiment, the amount of program code may be minimized and the time required for writing to a register may be relatively short.

Further, because the data DATA[15:0] on data bus 8 has to transition from write data to inverted write data at step 2 902, even if runaway by CPU 6 or the like causes the same command code to be repeatedly executed where a write is continuously executed to the same register, if the register is protected, the writing may be invalidated.

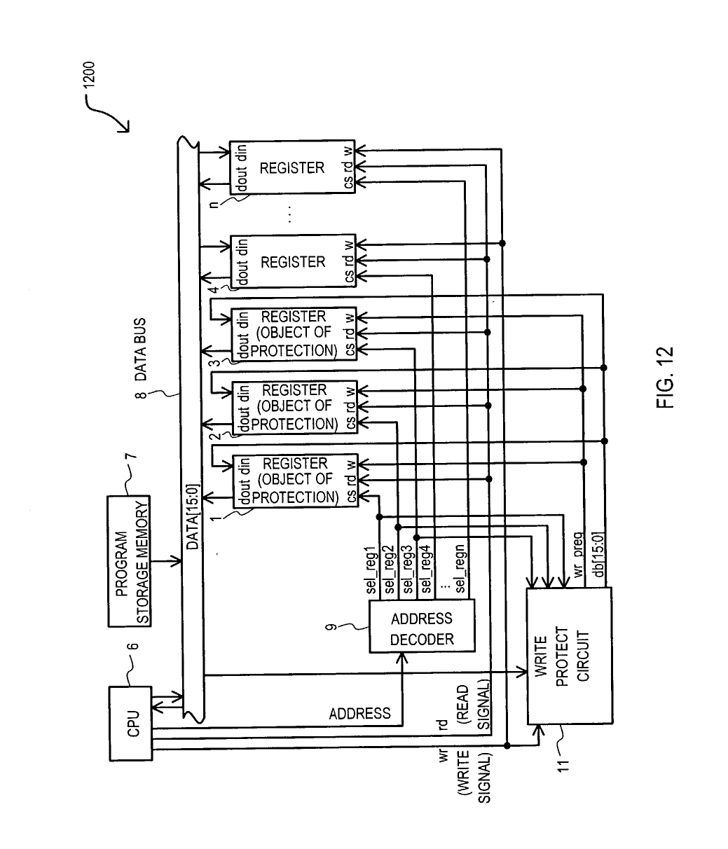

Another embodiment of the present invention will now be explained with reference to FIGS. 12 through 18. The embodiment illustrated in FIGS. 12 through 18 may have similar constituents as the embodiment illustrated in FIGS. 1 through 11, such constituents may be referred to by the same reference character.

Referring now to FIG. 12, a block schematic diagram of a system including a write protect circuit is set forth according to an embodiment and given the general reference character 1200. System 1200 may differ from system 100 of FIG. 1 in that 3 registers (1 to 3) may be write protected.

System 1200 may differ from system 100 of FIG. 1, in that system 1200 may include a write protect circuit 11. Write protect circuit 11 may only permit data to be written into any of registers (1 to 3) when a write operation is performed according to a specific sequence.

A predetermined value may be directly written into registers (4 through n), which are not write protected by applying a write signal wr from CPU 6. However, because a write signal wr_preg applied to a write terminal w of registers (1 to 3) is controlled by write protect circuit 11, registers (1 to 3) may not be written to unless a write operation following a specific sequence 600 (FIG. 6) is executed.

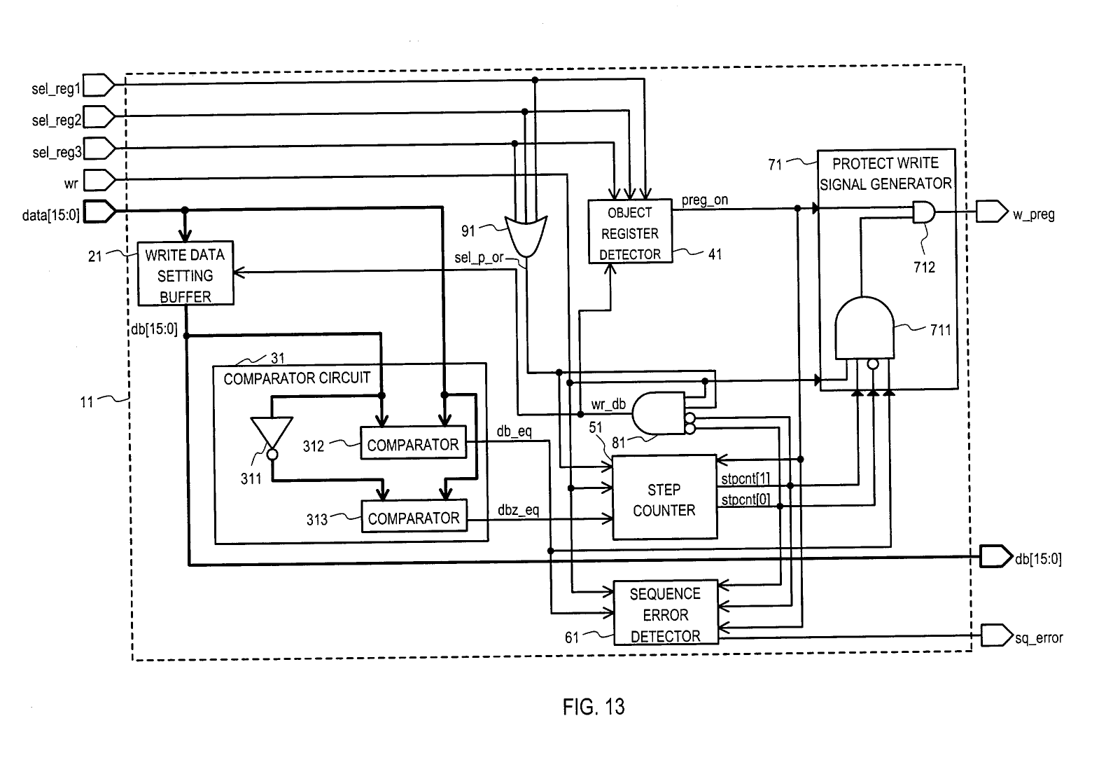

Referring now to FIG. 13, a circuit schematic diagram of write protect circuit 11 according to an embodiment is set forth.

Write protect circuit 11 may include a write data setting buffer 21, a comparator circuit 31, an object register detector 41, a step counter 51, a sequence error detector 61, a protect write signal generator 71, an AND gate 81, and an OR gate 91.

Write data setting buffer 21 may receive data data[15:0] and a signal wr_db and may provide data db[15:0]. Write data setting buffer 21 may latch a value of data data[15:0] received at step 1 901 to provide data db[15:0]. The construction of write data setting buffer 21 may be similar to write data setting buffer 20 of FIG. 2, so detailed explanation thereof is omitted.

Comparator circuit 31 may receive data DATA[15:0] and data db[15:0] and may provide match signals (db_eq and dbz_eq). Comparator circuit 31 may perform data comparison. Comparator circuit 31 may include comparing units (312 and 313) and an inverter 311. The construction of comparator circuit 31 may be similar to comparator circuit 30 of FIG. 2, so detailed explanation thereof is omitted.

Sequence error detector 61 may receive match signal db_eq, write signal wr, count signal stpcnt[1:0], and a detection signal preg_on and may provide an error signal sq_error.

Sequence error detector 61 may receive detection signal preg_on as compared to sequence error detector 60 of FIG. 2, which may receive select signal sel_reg1. Otherwise, the construction of sequence error detector 61 may be similar to sequence error detector 60 of FIG. 2, so detailed explanation thereof is omitted.

Protect write signal generator 71 may receive detection signal preg_on, write signal wr, count signal stpcnt[1:0], and match signal db_eq and may provide a write signal wr_preg. Protect write signal generator 71 may include AND gate 711 and AND gate 712. Protect write signal generator 71 may receive detection signal preg_on as compared to protect write signal generator 70 of FIG. 2, which may receive select signal sel_reg1. Otherwise, the construction of protect write signal generator 71 may be similar to protect write signal generator 70 of FIG. 2, so detailed explanation thereof is omitted.

AND gate 81 may receive protected select signal sel_p_or, write signal wr, inverted count bit stpcnt[1], and inverted count bit stpcnt[0] as inputs and may output a signal wr_db. AND gate 81 may receive protected select signal sel_p_or as compared to AND gate 80 of FIG. 2, which may receive select signal sel_reg1. Otherwise, the construction of AND gate 81 may be similar to AND gate 80 of FIG. 2, so detailed explanation thereof is omitted.

Object register detector 41 may receive select signals (sel_reg1 to sel_reg3) and signal wr_db and may provide detection signal preg_on. Object register detector 41 may detect whether the write operation following sequence 600 is being performed to the same protected register (sel_reg1 to sel_reg3).

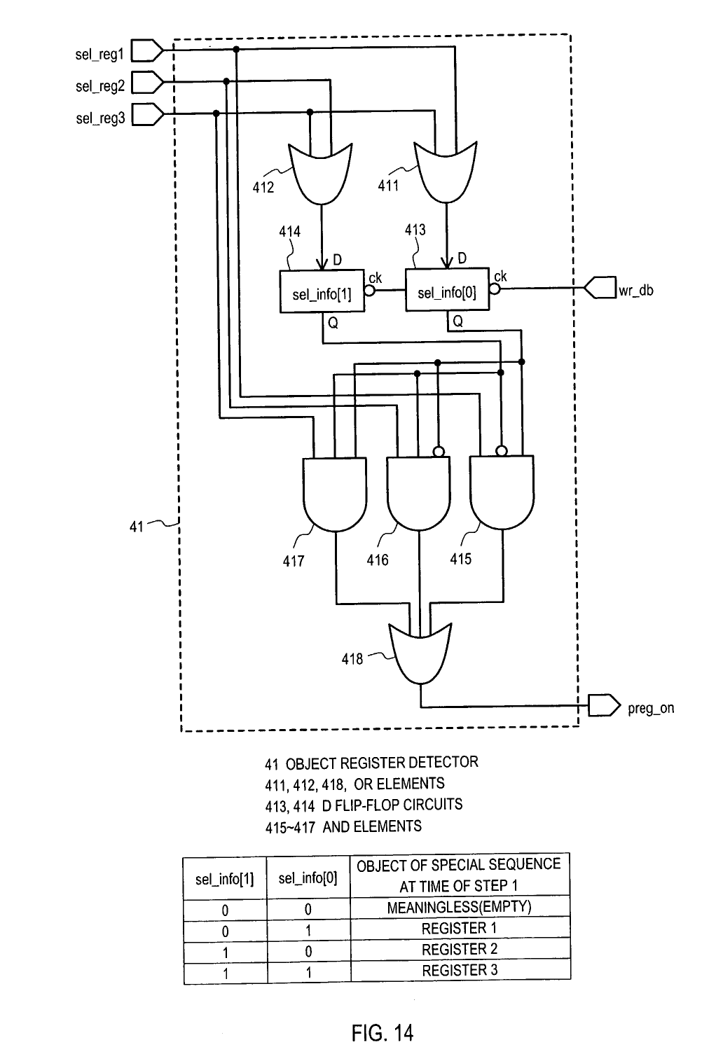

Referring now to FIG. 14, a circuit schematic diagram of object register detector 41 according to an embodiment is set forth.

Object register detector 41 may include OR gates (411, 412, and 418), flip-flops (413 and 414), and AND gates (415 to 417).

OR gate 411 may receive select signals (sel_reg1 and sel_reg3) and may provide an output as an input to flip-flop 413. OR gate 412 may receive select signals (sel_reg2 and sel_reg3) and may provide an output as an input to flip-flop 414. Flip-flop 413 may receive signal wr_db and may latch a received input from OR gate 411 on a falling edge of signal wr_db. Flip-flop 414 may receive signal wr_db and may latch a received input from OR gate 412 on a falling edge of signal wr_db. Flip-flops (413 and 414) may each be D-type flip-flops. AND gate 415 may receive an output from flip-flop 413, an inverted output from flip-flop 414, and select signal sel_reg2 and may provide an output to an input of OR gate 418. AND gate 416 may receive an inverted output from flip-flop 413, an output from flip-flop 414, and select signal sel_reg1 and may provide an output to an input of OR gate 418. AND gate 417 may receive an output from flip-flop 413, an output from flip-flop 414, and select signal sel_reg3 and may provide an output to an input of OR gate 418. OR gate 418 may provide detection signal preg_on as an output.

In FIG. 14, a value latched in flip-flop 413 may be referred to as sel_info[1]. A value latched in flip-flop 414 may be referred to as sel_info[1]. Values (sel_info[1] and sel_info[1]) may indicate the register (1 to 3) that is addressed during the write operation of step 1 601 of sequence 600. Values (sel_info[0] and sel_info[1]) may indicate a register (1 to 3) in accordance with the table illustrated in FIG. 14.

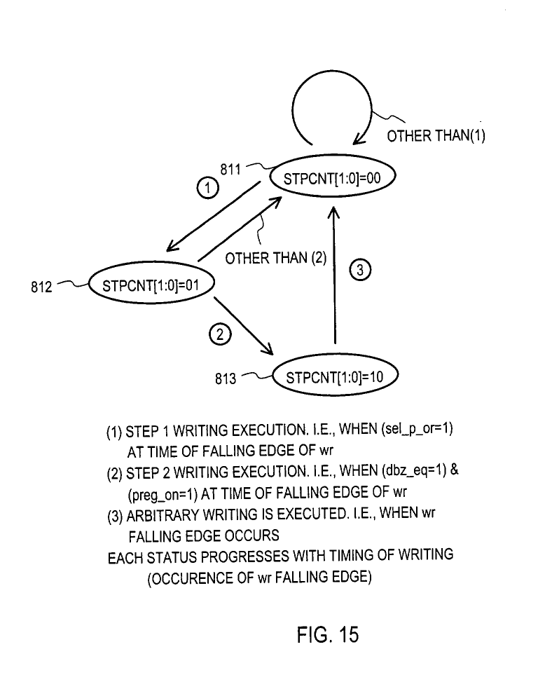

Referring now to FIG. 15, a state diagram illustrating a status progression of count signal stpcnt[1:0] according to an embodiment is set forth.

Step counter 51 may receive match signal db_eq, write signal wr, and protected select signal sel_p_or and provide count signal stpcnt[1:0] accordingly in response to an execution of a write command by CPU 6 (FIG. 1). More specifically, count signal stpcnt[1:0] may be set to a state (811 to 813) in response to a falling edge of write signal wr pulse provided by CPU 6.

If count signal stpcnt[1:0]=00b (state 811) and step 1 901 of a write sequence 600 is performed to a protected register (1 to 3), count signal stpcnt[1:0] may progress to a value of 01b (state 812). Then, if step 2 902 of a write sequence 600 is performed to the same protected register (1 to 3), count signal stpcnt[1:0] may progress to a value of 10b (state 813). When a different write occurs than in write sequence 600, count signal stpcnt[1:0] may return to a value of 00b. When count signal stpcnt[1:0] has a value of 10b and a write occurs, count signal stpcnt[1:0] may return to a value of 00b.

Value sel_info[1:0] latched by flip-flops (413 and 414) may be updated by a the writing performed when count signal stpcnt[1:0] has a value of 00b (811). Value sel_info[1:0] stored by flip-flops (413 and 414) may be treated as information indicating a protected register in accordance with an address ADDRESS value at step 1 901 (FIG. 6). AND gates (415 to 417) may detect whether the address ADDRESS corresponds to the same protected register as indicated by value sel_info[1:0] in subsequent steps (step 2 902 and step 3 903). Each AND gate (415 to 417) may provide an output to OR gate 418. In this way, OR gate 418 may provide a detection signal preg_on to indicate whether or not the same protected register (1 to 3) is being addressed during each step of sequence 600.

Object register detector 41 may be unnecessary when only one register is a protected register. However, when there are a plurality of protected registers, object register detector 41 may be necessary in order to determine the same protected register is being addressed in each step of sequence 600. If only two registers are protected registers, only a single bit may be latched (stored) in a flip-flop (or storing circuit). If three or four registers are protected registers, two bits may be latched (stored) in a flip-flop (or storing circuit). If five to seven registers are protected registers, three bits may be latched (stored) in a flip-flop (or storing circuit).

Because there is a plurality of registers to be protected (registers (1 to 3)) in the system 1200 illustrated in FIG. 12, step counter 51 in write protect circuit 11 may have a slightly different configuration as compared to step counter 50 in write protect circuit 10 illustrated in FIG. 2. In particular, as illustrated in the state diagram of FIG. 15, at the time of writing in accordance with step 1 811 (the case where protected select signal sel_p_or=1 at the falling edge of write signal wr), protected select signal sel_p_or may be used as a trigger to increment count bit stpcnt[0] from 0 to 1. In step counter 50 in write protect circuit 10 illustrated in FIG. 2, select signal sel_reg1 may be used as a trigger to increment count bit stpcnt[0] from 0 to 1. At the time of writing in accordance with step 2 812 (the case where match signal dbz_eq=1 and detection signal preg_on=1 at the falling edge of write signal wr), detection signal preg_on may be used as a trigger to increment count bit stpcnt[0] from 0 to 1. In step counter 50 in write protect circuit 10 illustrated in FIG. 2, select signal sel_reg1 may be used as a trigger to increment count bit stpcnt[0] from 0 to 1.

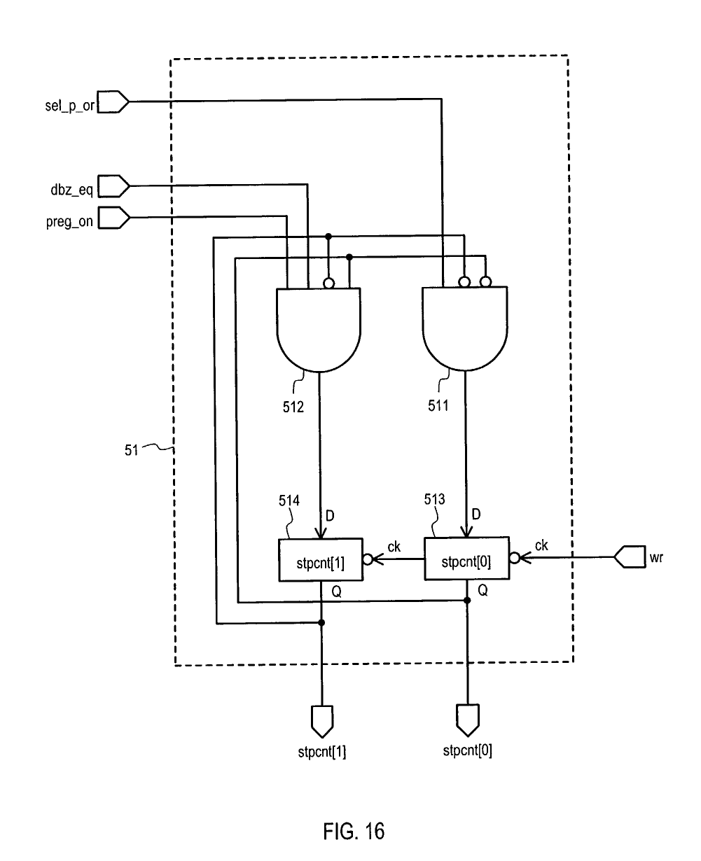

Referring now to FIG. 16 a circuit schematic diagram of step counter 51 according to an embodiment is set forth. Step counter 51 may provide count signal stpcnt[1:0] by following the state diagram illustrated in FIG. 15.

Step counter 51 may include AND gates (511 and 512) and flip-flop circuits (513 and 514). Flip-flop circuits (513 and 514) may be D-type flip-flop circuits. AND gate 511 may receive protected select signal sel_p_or, inverted count bit stpcnt[0] and inverted count bit stpcnt[1] and may provide a logical product output as an input to flip-flop circuit 513. AND gate 512 may receive detection signal preg_on, match signal dbz_eq, count bit stpcnt[0] and inverted count bit stpcnt[1] and may provide a logical product output as an input to flip-flop circuit 514.

Flip-flop circuit 513 may receive the logical product output from AND gate 511 and write signal wr. Flip-flop circuit 513 may latch the logical product output from AND gate 511 in response to an inverted write signal wr (i.e. at a falling edge of write signal wr) to provide count bit stpcnt[0] of count signal stpcnt[1:0]. Flip-flop circuit 514 may receive the logical product output from AND gate 512 and write signal wr. Flip-flop circuit 514 may latch the logical product output from AND gate 512 in response to an inverted write signal wr (i.e. at a falling edge of write signal wr) to provide count bit stpcnt[1] of count signal stpcnt[1:0].

Referring once again to FIG. 13, OR gate 91 may receive select signals (sel_reg1 to sel_reg3) and may generate protected select signal sel_p_or. Protected select signal sel_p_or may indicate whether or not a protected register has been addressed or selected. Protected select signal sel_p_or may be provided to step counter 51 and AND gate 81.

The operation of system 1200 including write protect circuit 11 will now be explained. System 100 (FIG. 1) may differ from system 1200 in that there are three protected registers (1 to 3). However, the basic operations are similar and explanations may be omitted.

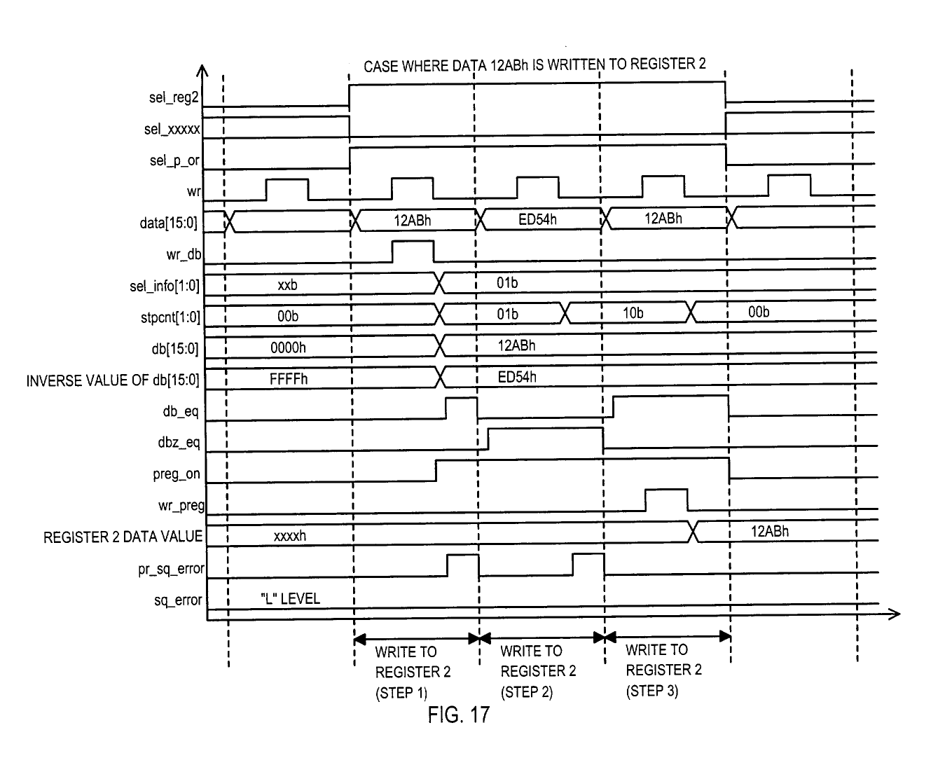

Referring now to FIG. 17, a timing diagram of a write to a protected register using sequence 600 according to an embodiment is set forth. The timing diagram of FIG. 17 illustrates a write of data DATA[15:0]=12ABh (h indicates that 12AB is a hexadecimal number) into register 2 following sequence 600 shown in FIG. 6.

The timing diagram illustrated in FIG. 17 is similar to timing diagram of FIG. 7, however, it should be noted that protected select signal sel_p_or may become logic high in step 1 (901) to indicate a protected register is being addressed (in this case register 2). Also, detection signal preg_on may be high in step 2 and step 3 (902 and 903) to indicate the same protected register (register 2) is being addressed as was addressed in step 1.

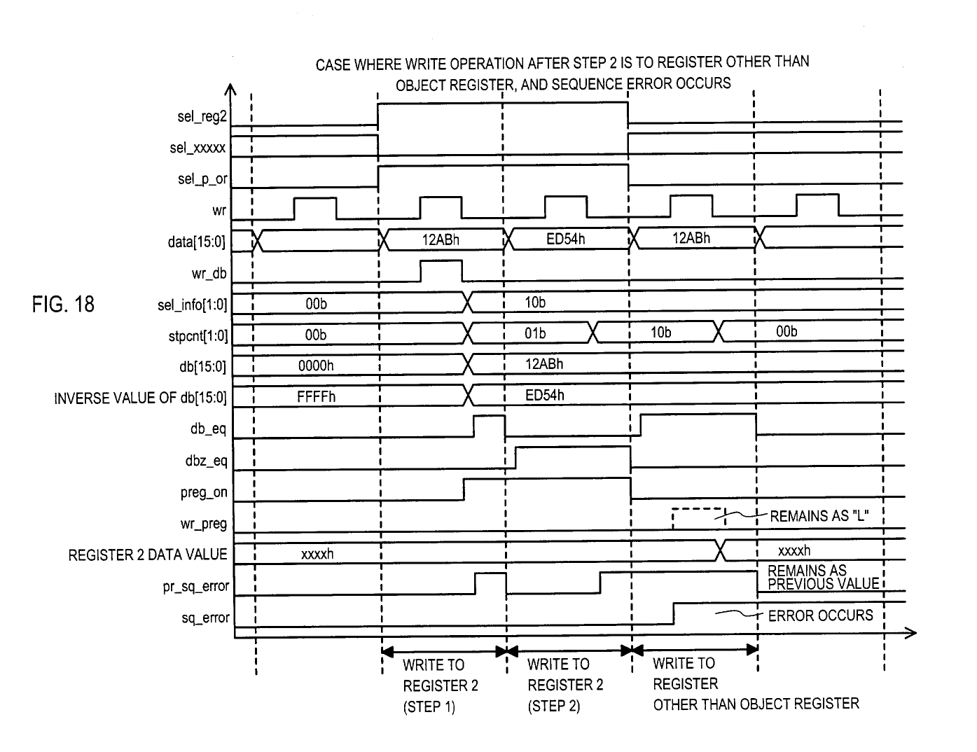

Referring now to FIG. 18, a timing diagram illustrating a case where an erroneous write operation to a register other than the object protected register 2 may occur after step 2 902 according to an embodiment is set forth.

In FIG. 18, in step 1 901, a write is executed to register 2. Thus, the protected register that is the object of the write sequence 600 is register 2. However, in step 3 903, a write is executed to another register (in this case, an unprotected register, such as registers (4 to n). Thus, in step 3 903, protected select signal sel_p_or may return low (thus indicating a protected register is not selected). Also, in step 3 903, detection signal preg_on may be low (thus indicating a write is not to the same register (register 2) as indicated by value sel_info[1:0] stored in object register detector 41). In this way, write signal wr_preg may be suppressed and writing of data (12ABh) to register 2 may not be performed. Accordingly, error signal sq_error having a high logic level may be provided to notify, for example, CPU 6 that writing did not occur.

As described above (FIGS. 12 to 18), an example of a case where a plurality of registers may be write protected. In this way, the number of registers which may be write protected can be altered in response to the needs of the system.

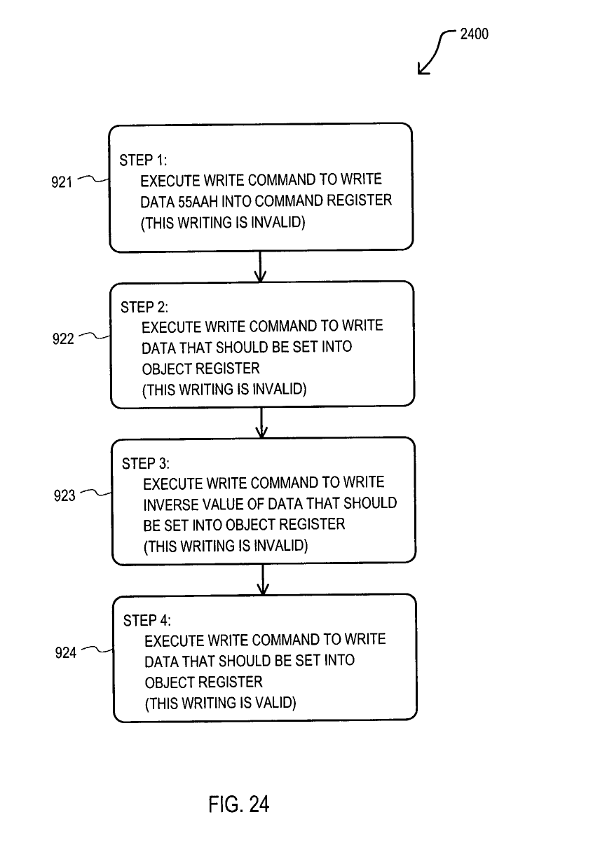

The write sequence to be executed to allow a write to a protected register should not be limited to three steps as in write sequence 600 (FIG. 6). An explanation will now be made for a write sequence including 4 steps as illustrated in FIG. 24.

Referring now to FIG. 24, a flow chart illustrating a write sequence according to an embodiment is set forth and given the general reference character 2400.

Write sequence 2400 may be similar to write sequence 600. However, write sequence 2400 may include a step (step 1 921) that may be inserted in the flow before step 1 901 of write sequence 600. In write sequence 2400, step 1 may include a write command to write data DATA[15:0] having a value of 55AAh into a command register. Steps 2 to 4 (922 to 924) of write sequence 2400 may be similar to steps 1 to 3 (901 to 903) of write sequence 600 of FIG. 6.

In the present embodiment, writing of data to a protected register may only be valid and allowed to occur when the four steps (Step 1 921, Step 2 922, Step 3 923, and Step 4 924) are followed.

Write operations of step 1 921, step 2 922, and step 3 923 may be included as steps in write sequence 2400. However, at the time of steps 1 to 3 (921 to 923) write signal wr_preg may not be provided and no write may occur. Writing may be valid at the time of step 4 924 only when steps 1 to 4 (921 to 924) are sequentially executed. When the write is valid, write signal wr_preg may be generated at step 4 924.

In a case where write sequence 2400 is not followed, the write operation may become invalid. For example, if another write operation is performed between step 1 921 and step 2 922, between step 2 922 and step 3 923, or between step 3 923 and step 4 924 the writing may become invalid and a sequence error may be detected. When a write to a protected register is attempted again, write sequence 2400 may begin again at step 1 921.

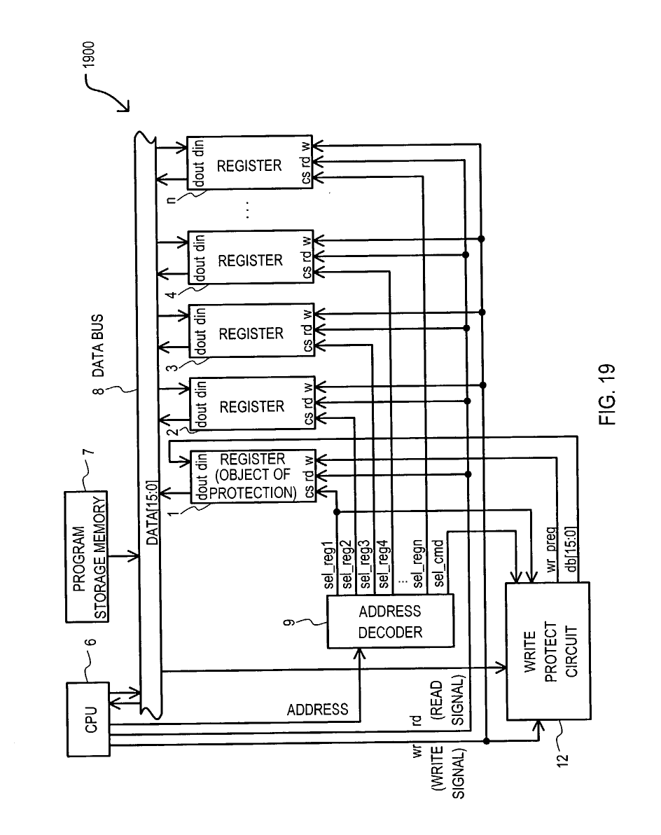

Referring now to FIG. 19, a block schematic diagram of a system including a write protect circuit is set forth according to an embodiment and given the general reference character 1900. System 1900 may be similar to system 100 of FIG. 1, however, system 1900 may include an address decoder 9 that can generate a command register select signal sel_cmd. System 1900 may also include a write protect circuit 12 that may receive command register select signal sel_cmd.

Command register select signal sel_cmd may be generated as a part of write sequence 2400. Step 1 921 of write sequence 921 may include a write command writing data 55AAH to a command register. A command register may not be an actual register, but may merely be assigned an address. Command register select signal sel_cmd may be generated by address decoder 9 in response to the assigned address.

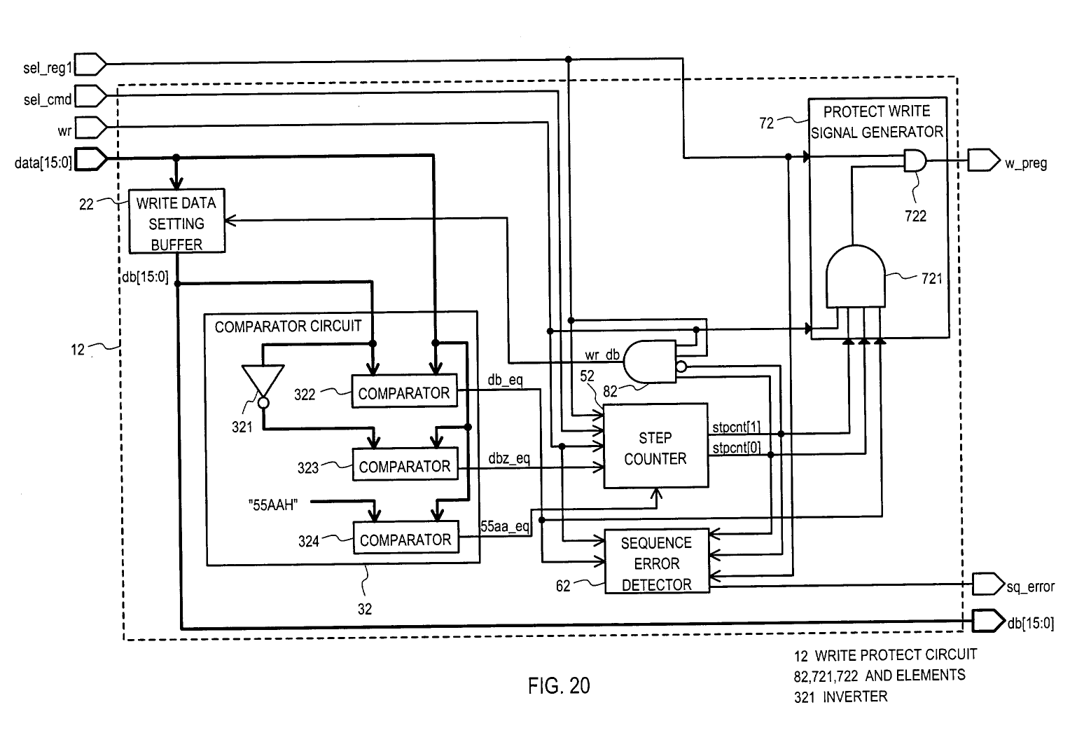

Referring now to FIG. 20, a circuit schematic diagram of write protect circuit 12 according to an embodiment is set forth.

Write protect circuit 12 may include a write data setting buffer 22, a comparator circuit 32, a step counter 52, a sequence error detector 62, a protect write signal generator 72, and an AND gate 82.

Write data setting buffer 22 may receive data data[15:0] and a signal wr_db and may provide data db[15:0]. Write data setting buffer 22 may latch a value of data data[15:0] received at step 1 921 to provide data db[15:0]. The construction of write data setting buffer 22 may be similar to write data setting buffer 20 of FIG. 2, so detailed explanation thereof is omitted.

Comparator circuit 32 may receive data DATA[15:0] and data db[15:0] and may provide match signals (db_eq and dbz_eq). Comparator circuit 32 may perform data comparison. Comparator circuit 31 may include comparing units (322, 323, and 324) and an inverter 321. The construction of comparator circuit 32 may differ from comparator circuit 30 of FIG. 2, in a comparing unit 324 may be included to compare a value of data data[15:0] from bus 8 with a value of 55AAh and output a match signal 55aa_eq.

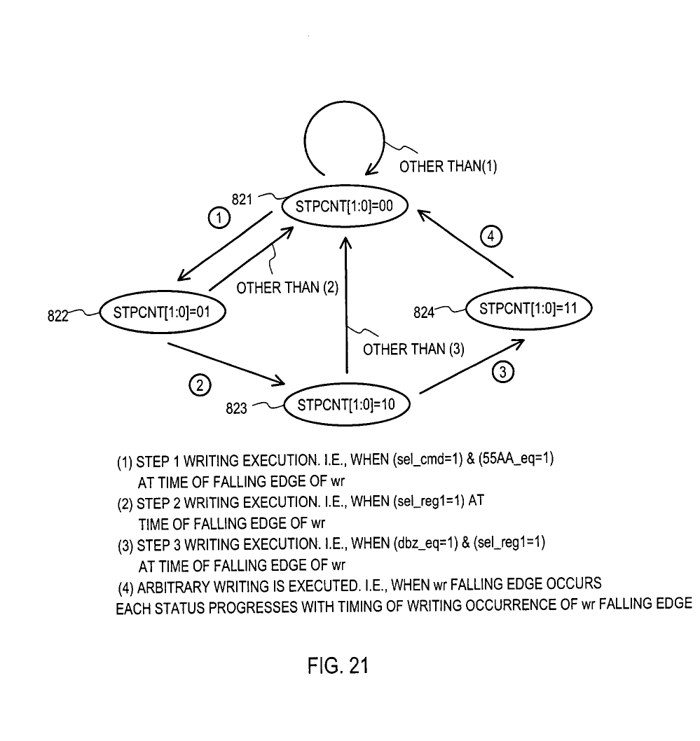

Referring now to FIG. 21, a state diagram illustrating a status progression of count signal stpcnt[1:0] according to an embodiment is set forth.

Step counter 52 may receive match signals (dbz_eq and 55aah), write signal wr, command register select signal sel_cmd and select signal sel_reg1 and provide count signal stpcnt[1:0] accordingly in response to an execution of a write command by CPU 6 (FIG. 19). More specifically, count signal stpcnt[1:0] may be set to a state (821 to 824) in response to a falling edge of write signal wr pulse provided by CPU 6.

If count signal stpcnt[1:0]=00b (state 821) and step 1 921 of a write operation is performed, count signal stpcnt[1:0] may progress to a value of 01b (state 822). Then, if step 2 922 of a write operation is performed, count signal stpcnt[1:0] may progress to a value of 10b (state 823). Then, if step 3 923 of a write operation is performed, count signal stpcnt[1:0] may progress to a value of 11b (state 824). When a different write occurs, count signal stpcnt[1:0] may return to a value of 00b. When count signal stpcnt[1:0] has a value of 11b and a write (step 4 924) occurs, count signal stpcnt[1:0] may return to a value of 00b.

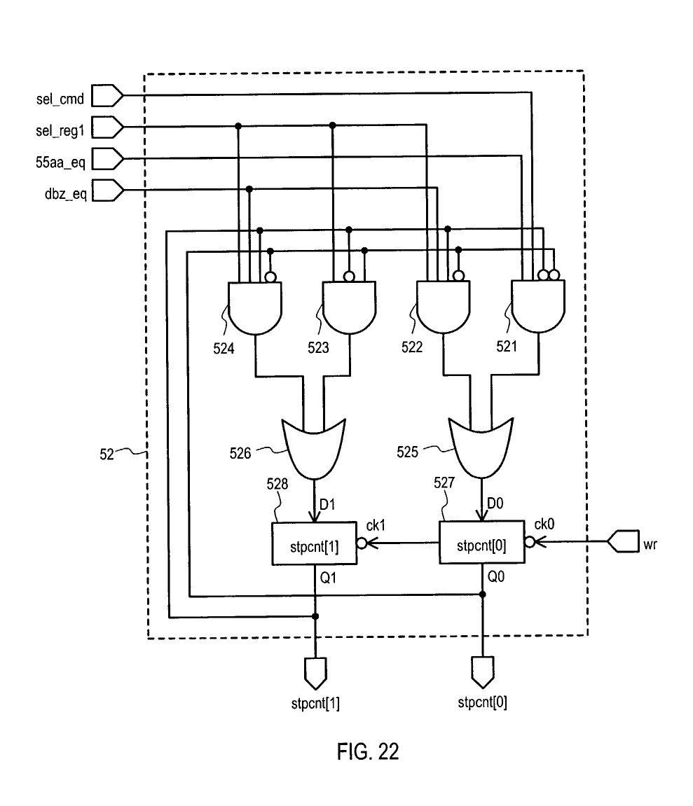

Referring now to FIG. 22, a circuit schematic diagram of step counter 52 according to an embodiment is set forth. Step counter 52 may provide count signal stpcnt[1:0] by following the state diagram illustrated in FIG. 21.

Step counter 52 may include AND gates (521 to 524), OR gates (525 and 526), and flip-flop circuits (527 and 528). Flip-flop circuits (527 and 528) may be D-type flip-flop circuits. AND gate 521 may receive command register select signal sel_cmd, match signal 55aa_eq, inverted count bit stpcnt[0] and inverted count bit stpcnt[1] and may provide a logical product output as an input to OR gate 525. AND gate 522 may receive select signal sel_reg1, inverted count bit stpcnt[0] and count bit stpcnt[1] and may provide a logical product output as an input to OR gate 525. AND gate 523 may receive select signal sel_reg1, count bit stpcnt[0] and inverted count bit stpcnt[1] and may provide a logical product output as an input to OR gate 526. AND gate 524 may receive select signal sel_reg1, match signal dbz_eq, inverted count bit stpcnt[0] and count bit stpcnt[1] and may provide a logical product output as an input to OR gate 526. OR gate 525 may provide an output as an input D0 to flip-flop circuit 527. OR gate 526 may provide an output as an input D1 to flip-flop circuit 528.

Flip-flop circuit 527 may receive the output from OR gate 525 and write signal wr. Flip-flop circuit 527 may latch the output from OR gate 525 in response to an inverted write signal wr (i.e. at a falling edge of write signal wr) to provide count bit stpcnt[0] of count signal stpcnt[1:0]. Flip-flop circuit 528 may receive the output from OR gate 526 and write signal wr. Flip-flop circuit 528 may latch the output from OR gate 526 in response to an inverted write signal wr (i.e. at a falling edge of write signal wr) to provide count bit stpcnt[1] of count signal stpcnt[1:0].

Referring once again to FIG. 20, sequence error detector 62 may receive match signal db_eq, write signal wr, count signal stpcnt[1:0], and select signal sel_reg1 and may provide an error signal sq_error. Sequence error detector 62 may detect whether write sequence 2400 has been performed normally (followed) or not. When write sequence 600 is not followed, sequence error detector 62 may provide error signal sq_error having an error logic state. Error signal sq_error may be provided to CPU 6 (FIG. 19) as a flag, an interrupt request or the like even though this connection is not illustrated in FIG. 19. Error signal sq_error may indicate that a different write operation was performed between step 1 921 and step 2 922, between step 2 922 and step 3 923, or between step 3 923 and step 4 924 in sequence 2400 (FIG. 24).

Sequence detector 62 may detect an error in 6 cases.

Examples of the six cases will be given when sequence detector 62 may generate an error signal sq_error indicating an invalid write (first write). A first case is when a first write operation to a protected register 1 occurs without previously writing 55AAh to the command register. In a second case, a first write operation to a register other than protected register 1 may occur after step 1 921. In a third case, a first write operation to a register other than protected register 1 may occur after step 2 922. In a fourth case, a first write operation may occur after step 2 922 with a value other than inverted data (as compared to data data[15:0] in step 2 922). In a fifth case, a first write operation to a register other than protected register 1 may occur after step 3 923. In a sixth case, a first write operation may occur after step 3 923 with a value other than data (data data[15:0] in step 2 922). When any of the six above-mentioned cases occur, write sequence 2400 has been interrupted or violated. In response to the violation of write sequence 2400, writing to register 1 (a register protected by write protect circuit 12) may be invalidated and thus, not take place and error signal sq_error may be output having an error logic state.

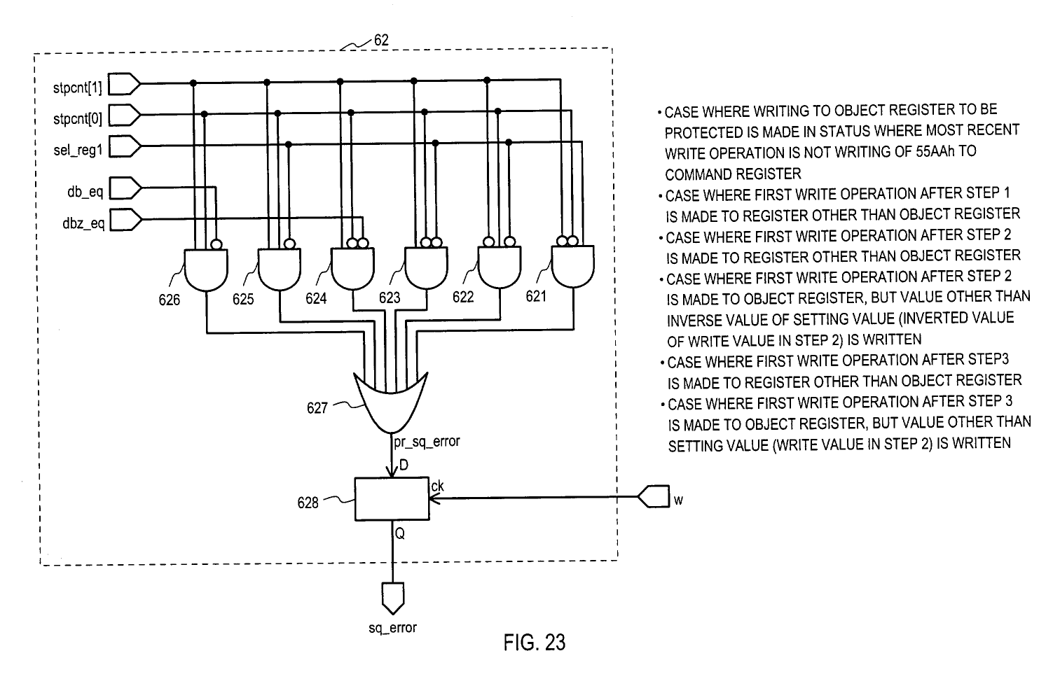

Referring now to FIG. 23, a circuit schematic diagram of sequence error detector 62 according to an embodiment is set forth.

Sequence error detector 62 may include AND gates (621 to 626), OR gate 627, and flip-flop circuit 628.

AND gate 621 may receive an select signal sel_reg1, inverted step count bit stpcnt[1], and inverted step count bit stpcnt[0] and may provide an output as an input to OR gate 627. AND gate 622 may receive an inverted select signal sel_reg1, inverted step count bit stpcnt[1], and step count bit stpcnt[0] and may provide an output as an input to OR gate 627. AND gate 623 may receive an inverted select signal sel_reg1, inverted step count bit stpcnt[0], and step count bit stpcnt[1] and may provide an output as an input to OR gate 627. AND gate 624 may receive step count bit stpcnt[1], inverted step count bit stpcnt[0], and inverted match signal dbz_eq and may provide an output as an input to OR gate 627. AND gate 625 may receive an inverted select signal sel_reg1, step count bit stpcnt[1], and step count bit stpcnt[0] and may provide an output as an input to OR gate 627. AND gate 626 may receive an inverted match signal db_eq, step count bit stpcnt[1], and step count bit stpcnt[0] and may provide an output as an input to OR gate 627.

OR gate 627 may provide an output signal pr_sq_error as an input to flip-flop 628.

Flip-flop 628 may be a D flip-flop. Flip-flop 628 may receive write signal wr at a clock ck input and may output error signal sq_error. Flip-flop 628 may latch the received signal pr_sq_error to provide error signal sq_error in response to a falling edge of write signal wr.

The above-mentioned first case may be detected by AND gate 621. The second case may be detected with AND gate 622. The third case may be detected with AND gate 623. The fourth case may be detected with AND gate 624. The fifth case may be detected with AND gate 625. The sixth case may be detected with AND gate 626. Output signals from AND gates (621 to 626) may be respectively provided as inputs to OR gate 627 to generate output signal pr_sq_error which may be latched by flip-flop 628 in response to a rising edge of write signal wr and output as error signal sq_error.

The operation of the system 1900 including write protect circuit 12 will now be explained.

First, an operation where a write to a protected register using sequence 2400 will be explained. Note the present embodiment may include a 4-step write sequence 2400, but the basic operation may be similar to that of each of the above-mentioned embodiments.

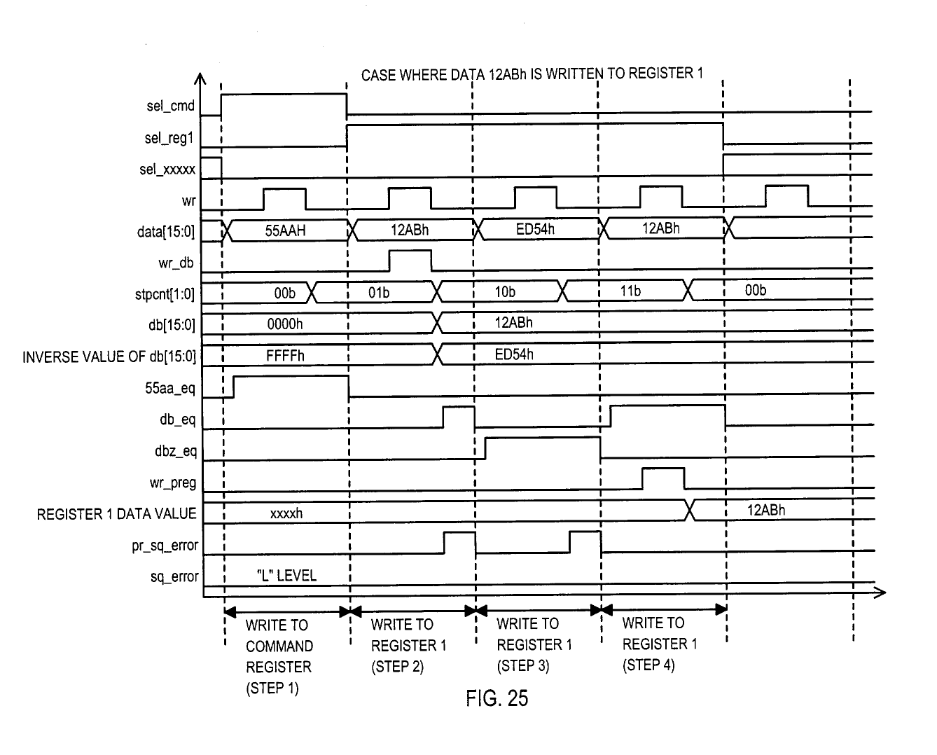

Referring to FIG. 25, a timing diagram of a write to a protected register using sequence 2400 according to an embodiment is set forth. The timing diagram of FIG. 25 illustrates a write of data DATA[15:0]=12ABh (h indicates that 12AB is a hexidecimal number) into register 1 following sequence 2400 shown in FIG. 24.

Referring now to FIG. 25 in conjunction with FIGS. 19 to 24, first at step 1 921, a write command may be executed to a register (register address applied to address decoder 9). Thus, data data[15:0] having a value of 55AAh may be applied to address bus 8 and command register select signal sel_Cmd may be a high logic level. Also, comparator circuit 324 may provide a match signal 55aa_eq having a high logic level. Also, at this time, AND gate 521 in step counter 52 may be enabled (in response to count signal stpcnt[1:0]=00b and select signal sel_reg1 and command register select signal cmd_sel being high) and may provide a high output as an input to OR gate 525. Thus, OR gate 525 may provide a high output to flip-flop 527. As a result, flip-flop 527 may latch a high level count bit stpcnt[0] in response to a falling edge of write signal wr. In this way, count signal stpcnt[1:0] may advance to a value of 01b.

Next, a write command may be executed to register 1 as step 2 922. In step 1 922, select signal sel_reg1 may become active (high) while other select signals (sel_reg2 to sel_regn) may be low (illustrated as signal sel_xxxxx in FIG. 25). Also, in step 2 922, CPU 6 may apply a value of 12ABh as data data[15:0] to data bus 8 and may provide write signal wr having a pulse. Because at this time step counter 60 outputs a count signal stpcnt[1:0]=01b, AND gate 82 may output a signal wr_db as a pulse (following write signal wr). In response to signal wr_db, write data setting buffer 22 may latch received data data[1:0] and provide data db[15:0] having a value of 12ABh to comparator circuit 322. Inverter 321 may provide inverted data having a value of ED54h to comparator circuit 323. In this case, comparator circuit 322 may detect a match between data DATA[15:0] and data db[15:0] and may output a match signal db_eq having a high logic level. However, comparator circuit 323 may not detect a match between data data[15:0] and inverted data db[15:0] and may output a match signal dbz_eq having a low logic level.

Also, at this time, AND gates (521 and 522) in step counter 52 may be disabled (in response to count signal bit stpcnt[10]=01b) and may provide a low outputs as an inputs to OR gate 525. Thus, OR gate 525 may provide a low output to flip-flop 527. As a result, flip-flop 527 may latch a low level count bit stpcnt[0] in response to a falling edge of write signal wr. Also, at this time, AND gate 523 in step counter 52 may be enabled (in response to count signal stpcnt[1:0]=01b and select signal sel_reg1 being high) and may provide a high output as an input to OR gate 526. Thus, OR gate 526 may provide a high output to flip-flop 528. As a result, flip-flop 528 may latch a high level count bit stpcnt[1] in response to a falling edge of write signal wr. In this way, count signal stpcnt[1:0] may advance to a value of 10b.

Next, another write command may be executed as step 3 923. In step 3 923, select signal sel_reg1 may remain high while other select signals (sel_reg2 to sel_regn) may be low (illustrated as signal sel_xxxxx in FIG. 25). Also, in step 3 923, CPU 6 may apply a value of ED54h as data data[15:0] to data bus 8 and may provide write signal wr having a pulse. In this case, comparator circuit 323 may detect a match between data data[15:0] and inverted data db[15:0] and may output a match signal dbz_eq having a high logic level. However, comparator circuit 322 may not detect a match between data data[15:0] and data db[15:0] and may output a match signal db_eq having a low logic level.

Also, at this time, AND gates (524 and 522) in step counter 52 may be enabled (in response to count signal bit stpcnt[1:0]=10b, select signal sel_reg1 being high, and match signal dbz_eq being high) and may respectively provide a high output as an input to OR gates (525 and 526). OR gates (525 and 526) may each provide a high output as an input to a respective flip-flop circuit (527 and 528). As a result, flip-flop circuit 528 may latch a high level count bit stpcnt[1] and flip-flop 527 may latch a high level count bit stpcnt[0] in response to a falling edge of write signal wr. In this way, count signal stpcnt[1:0] may advance to a value of 11b.

Next, another write command may be executed as step 4 924. In step 4 924, select signal sel_reg1 may remain high while other select signals (sel_reg2 to sel_regn) may be low (illustrated as signal sel_xxxxx in FIG. 25). Also, in step 4 924, CPU 6 may apply a value of 12ABh as data DATA[15:0] to data bus 8 and may provide write signal wr having a pulse. In this case, comparator circuit 322 may detect a match between data data[15:0] and db[15:0] and may output a match signal db_eq having a high logic level. However, comparator circuit 323 may not detect a match between data DATA[15:0] and inverted data db[15:0] and may output a match signal dbz_eq having a low logic level.

At this time, AND gate 721 in protect write signal generator 72 may provide a high output (because count signal stpcnt[1:0]=11b, write signal wr is high, and match signal db_eq is high). Thus, AND gate 722 may generate write signal wr_preg. Write signal wr_preg may be a pulse essentially following write signal wr during step 4 924.

In response to write signal wr_preg having a pulse and select signal sel_reg1 being high, data db[15:0] (12ABh in the present example as latched by write data setting buffer 22) may be written into register 1.

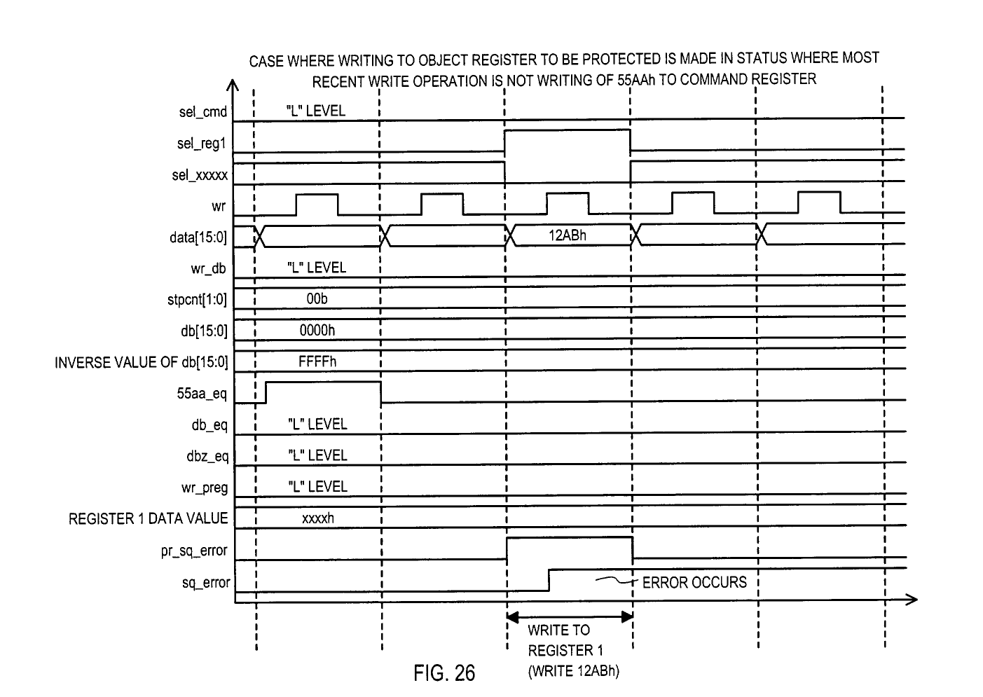

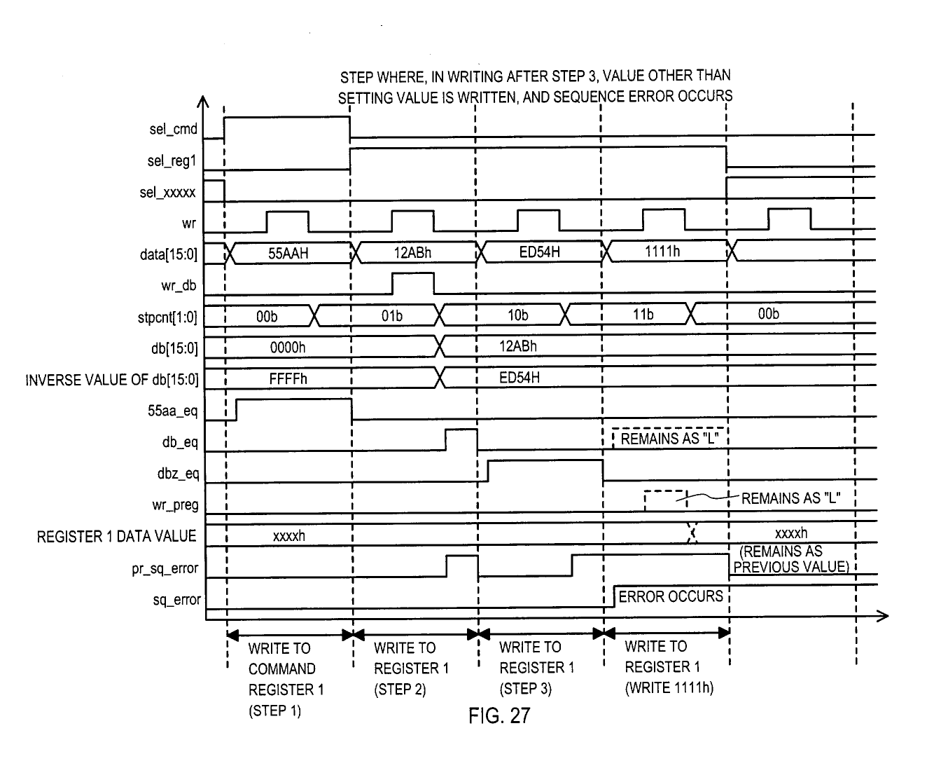

Now, using timing diagrams of FIGS. 26 and 27, an explanation will be made for cases where a write sequence is initiated to register 1, however, write sequence 2400 is not followed and the write becomes invalid.

Referring now to FIG. 26, a timing diagram illustrating a case where an erroneous write operation to protected register 1 may occur without a preceding write operation writing 55AAh to a command register according to an embodiment is set forth.

The timing diagram of FIG. 26 may illustrate the above-mentioned first case of an erroneous write.

Referring now to FIG. 26 in conjunction with FIGS. 19 to 24, select signal sel_reg1 may go high to select register 1. However, because count signal stpcnt[1:0]=00b at this time, AND gate 621 in sequence error detector 62 may provide a high logic level as an input to OR gate 627. Thus, OR gate 627 may provide a signal pr_sp_error having a high logic level. Flip-flop 628 may then provide an error signal sq_error having a high logic level upon a rising edge of write signal wr.

Referring now to FIG. 27, a timing diagram illustrating a case where an erroneous write operation may occur after step 3 923 with a value other than data (as compared to data DATA[15:0] in step 2 922) according to an embodiment is set forth.

The timing diagram of FIG. 27 may illustrate the above-mentioned first case of an erroneous write.

Referring now to FIG. 27 in conjunction with FIGS. 19 to 24, steps 1 to 3 (921 to 923) may be performed in accordance with sequence 2400 in essentially the same manner as steps 1 to 3 (921 to 923) in the timing diagram of FIG. 25. Next a write (after step 3 923) is made to register 1 with data DATA[15:0] having a value other than data data[15:0] in step 2 922. For example, data data[15:0] may have a value of 1111h while data db[15:0] (from step 2) may have a value of 12ABh. Thus, match signal db_eq may remain at a low logic level. AND gate 626 in sequence error detector 62 may receive the low match signal db_eq and count signal stpcnt[1:0]=11b and may provide a high output. In this way, OR gate 627 may provide an output signal pr_sq_error having a high logic level. Flip-flop 627 may then provide an error signal sq_error having a high logic level upon a rising edge of write signal wr. Furthermore, with match signal db_eq having a low logic level, AND gate 721 in protect write signal generator 72 may provide an output having a logic low. In this way, AND gate 722 may provide a write signal wr_preg having a logic low level and a write to register 1 may be prevented.

As described above, in accordance with this embodiment, the number of steps in write sequence 2400 may be increased to four steps. Also, a specific value may be written into a specific address (command register) to indicate write sequence 2400 may be performed. In this way, repeated erroneous writing of a random value to the same register due to runaway by a CPU 6 or the like, may be prevented. Runaway by a CPU 6 may occur, for example, when CPU 6 is stuck in a loop.

Further, in accordance with the embodiments, it may not be necessary to include an extra (parity) bit of data to ensure data on data bus 8 has not been corrupted. Thus, error correction circuitry may not be necessary. In this way, the method of write protection according to the embodiments may be implemented with a relatively small amount of circuitry.

Further, the method of write protection according to the embodiments may be implemented by using circuitry for temporarily storing the write data while software may perform the detection (data comparison, or the like) to determine whether the write data is valid. However, it should be noted, that detection by software may increase the program code and may increase the time required to write to a register. In comparison, the above embodiments may have the effect that it may be sufficient to execute a write command three times to ensure a desired write to a protected register has occurred. In this way, the program code may be reduced and the time required to write to a register may be reduced.

As described above, in accordance with a write protection method of the embodiments, a determination may be made whether or not a write operation to a protected register has been performed in accordance with a specific write sequence. A control may be performed so that the writing of data to a protected register may only occur when a specific write sequence has been executed. In this way, undesired writes to a protected register may be prevented.

It is understood that the embodiments described above are exemplary and the present invention should not be limited to those embodiments. Specific structures should not be limited to the described embodiments.

Thus, while the various particular embodiments set forth herein have been described in detail, the present invention could be subject to various changes, substitutions, and alterations without departing from the spirit and scope of the invention. Accordingly, the present invention is intended to be limited only as defined by the appended claims.

What is claimed is:

1. A write protect method for preventing an erroneous write to a predetermined register, comprising the steps of:
determining whether or not a write operation for writing data to the predetermined register was performed according to a predetermined write sequence including at least a first and second write command; and
controlling the writing of the data to the predetermined register so that the writing of data is only performed when it is determined in the determining step that the write operation for writing data to the predetermined register was performed according to the predetermined write sequence.

2. The write protect method according to claim 1, wherein:
the step of determining includes verifying the data by performing a data comparison.

3. The write protect method according to claim 1, wherein:
the first write command includes providing the data on a data bus and providing a first address corresponding to the predetermined register; and
the second write command includes providing inverse data on the data bus and providing the first address corresponding to the predetermined register.

4. The write protect method according to claim 3, wherein:
the predetermined write sequence further includes a third write command;
the third write command includes providing the data on the data bus and providing the first address corresponding to the predetermined register; and
the predetermined write sequence is executed in the order of first write command, second write command, and third write command.

5. The write protect method according to claim 3, wherein:
the predetermined write sequence further includes a third write command;
the third write command includes providing a predetermined value to the data bus and a second address;
the predetermined write sequence is executed in the order of third write command, first write command, and second write command.

6. The write protect method according to claim 1, further including the step of:
providing an error signal to a processing unit when it is determined that the write operation for writing data to the predetermined register was not performed according to the predetermined write sequence.

7. The write protect method according to claim 1, wherein:
the step of determining whether or not a write operation has been performed is executed by a computing device in accordance with a write protect program.

8. A write protect system for preventing an erroneous write to a first register, comprising:
a write protect circuit that determines whether or not a write operation for writing data to the first register was performed according to a predetermined write sequence including at least a first and second command and controlling the writing of the data to the first register so that the writing of data is only performed when it is determined that the write operation for writing data to the first register was performed according to the predetermined write sequence.

9. The write protect system according to claim 8, wherein:
the write protect circuit is coupled to receive the data from a data bus coupled to a processor.

10. The write protect system according to claim 8, wherein:
the write protect circuit is coupled to receive the data in the first command and coupled to receive different data in the second command.

11. The write protect system according to claim 10, wherein:
the predetermined write sequence includes a third command; and
the write protect circuit is coupled to receive the data in the third command and the predetermined write sequence is executed in the order of first command, second command, and third command.

12. The write protect system according to claim 10, wherein:
the write protect circuit is coupled to receive at least one register select signal having a first register select value in the first and second commands;
the predetermined write sequence includes a third command; and
the write protect circuit is coupled to receive a predetermined data value in the third command and the at least one register select signal having a command register select value.

13. The write protect system according to claim 8, wherein:
the write protect circuit resets to detect the first command in the predetermined sequence when it is determined that the predetermined sequence has not been followed.

14. The write protect system according to claim 8, wherein:
the write protect circuit is coupled to receive the data in the first command and coupled to receive inverse data in the second command.

15. A write protect system for preventing an erroneous write to a first storage circuit, comprising:
a write protect circuit that determines whether or not a write operation for writing data to the first storage circuit was performed according to a predetermined write sequence including at least a first and second command and controlling the writing of the data to the first storage circuit so that the writing of data is only performed when it is determined that the write operation for writing data to the first storage circuit was performed according to the predetermined write sequence.

16. The write protect system according to claim 15, wherein:
the write protect circuit includes a data latch circuit coupled to receive the data and provide latched data in response to the first command.

17. The write protect system according to claim 16, wherein:
the write protect circuit includes a comparator circuit coupled to receive the latched data and second command data and provide a comparison result.

18. The write protect system according to claim 17, wherein:
the comparison result includes a match signal indicating a comparison between the latched data and the second command data.

19. The write protect system according to claim 15, wherein:
the write protect circuit includes a state circuit providing a write sequence state indicating a progression of the write sequence.

20. The write protect system according to claim 19, wherein:
the write protect circuit includes a sequence error detector coupled to receive the write sequence state and provide a sequence error signal.
